(19) United States
(12) Patent Application Publication
(10) Pub. No.: US 2009/0000444 A1
(43) Pub. Date: Jan. 1, 2009

(54) Cutting Apparatus

(75) Inventors: Jonathan Aaron Johnson, Orem, UT (US); Phil Beffrey, Petaluma, CA (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Provo Craft and Novelty, Inc., Spanish Fork, UT (US)

(21) Appl. No.: 12/020,545

(22) Filed: Jan. 27, 2008

Related U.S. Application Data
(63) Continuation-in-part of application No. 11/457,415, filed on Jul. 13, 2006.
(60) Provisional application No. 60/897,563, filed on Jan. 26, 2007.
(60) Provisional application No. 60/699,210, filed on Jul. 14, 2005.

(51) Int. Cl. B26D 5/00; B26D 5/06

(52) U.S. Cl. 83/76.1; 83/76.9; 83/548

(57) ABSTRACT

An apparatus includes a housing and a cutting mechanism coupled to said housing and configured for cutting a sheet. The apparatus further includes a user interface incorporated into said housing for allowing a user to select through said user interface at least one shape to be cut by said cutting mechanism. Additionally, the apparatus includes a processor housed within said housing for controlling movement of said cutter assembly and for receiving commands through said user interface. The apparatus also includes a memory device in communication with said processor, said memory device containing a library of shapes to be cut with said cutting mechanism for selecting by a user through said user interface

### CROSS REFERENCE TO RELATED APPLICATIONS

This application claims priority under 35 U.S.C. § 119(e) to U.S. Provisional Patent Application No. 60/897,563 filed on Jan. 26, 2007, titled “Electronic Cutting Apparatus and Methods for Cutting”, to Workman et al., and this application is a continuation-in-part of application Ser. No. 11/457,415 filed Jul. 13, 2006, titled “Electronic Paper Cutting Apparatus”, to Workman et al., which claim priority to U.S. provisional application 60/699,210 filed on Jul. 14, 2005, titled “Electronic Cutting Apparatus and Methods for Cutting”, to Workman et al., all of which are incorporated herein by reference.

### FIELD

The present invention relates generally to an electronic cutting machine, and more particularly to an electronic cutting machine that may be operated as a stand-alone machine without the need of connection to any other peripheral device such as a personal computer.

### BACKGROUND

As scrapbooking has become a national phenomenon, various new products have been introduced to the mark to embellish and customize scrapbook pages. One product that has seen significant commercial success has been the introduction of various die cutting devices. Die cutting devices typically employ the use of one or more dies having a cutting blade of a particular configuration and a press for firmly pressing a die against a sheet of paper or other material in sheet form to cut the sheet with the die into the desired shape. These systems are typically hand operated.

Another system for cutting shapes in sheet materials is an electronic vinyl cutter. Electronic vinyl cutters are configured to cut a shape or series of shapes in a sheet of adhesive backed vinyl that can be peeled from the sheet and applied to another material, such as a banner, for forming a relatively inexpensive sign. These electronic vinyl cutters are relatively expensive and require connection to a computer and computer software to drive the electronic cutter.

The electronic vinyl cutters have been employed to cut paper materials for use in the arts and crafts industry. The machines, however, are connected to an external computer running software to control the movement of the cutter. In addition, the machines themselves are not generally configured in a manner that makes them simple to operate.

As such, there exists a need for an electronic cutting machine that is configured specifically for cutting paper and other materials in sheet form that is easy to operate and can operate independently of a personal computer or other external device.

### BRIEF DESCRIPTION OF THE DRAWINGS

The features and inventive aspects will become more apparent upon reading the following detailed description, claims, and drawings, of which the following is a brief description. The following drawings illustrate exemplary embodiments. Like reference numerals refer to like parts in different views or embodiments in the drawings.

FIG. 1A is a perspective front view of an electronic cutter in a closed configuration in accordance with the principles of the present invention.

FIG. 1B is a perspective front view of the electronic cutter shown in FIG. 1 with the doors removed.

FIG. 1C is a front view of the electronic cutter of FIG. 1A.

FIG. 1D is an exploded perspective front view of the electronic cutter of FIG. 1A.

FIG. 1E is a top view of the electronic cutter of FIG. 1A.

FIG. 1F is a side view of the electronic cutter of FIG. 1A.

FIG. 2A is a front perspective view of the cutter of FIG. 1A in an open configuration.

FIG. 2B is a front perspective view of a user interface and user display of the electronic cutter of FIG. 1A.

FIG. 2C is a side cross-sectional view of the user display of FIG. 2B.

FIG. 3A is a top view of a first example of a user interface for use with the electronic cutter of FIG. 1A.

FIG. 3B is a top view of a second example of a user interface for use with the electronic cutter of FIG. 1A.

FIG. 3C is a top view of a third example of a user interface for use with the electronic cutter of FIG. 1A.

FIG. 3D is a top view of a fourth example of a user interface for use with the electronic cutter of FIG. 1A.

FIG. 3E is a top view of a fifth example of a user interface for use with the electronic cutter of FIG. 1A.

FIG. 4 is a top view of a keyboard overlay in accordance with the principles of the present invention.

FIG. 5A is a perspective top view of an “ON” switch in accordance with the principles of the present invention.

FIG. 5B is an exploded perspective top view of the “ON” switch shown in FIG. 5A.

FIG. 6 is a perspective front view of a cutter assembly in accordance with the principles of the present invention.

FIG. 7 is a perspective front view of a roller assembly in accordance with the principles of the present invention.

FIG. 8A is a perspective side view of a blade holder in accordance with the principles of the present invention.

FIG. 8B is an exploded perspective view of the blade holder shown in FIG. 8A.

FIG. 8C is a cross-sectional side view of the blade holder shown in FIG. 8A.

FIG. 8D is a partial cross-sectional side view of an alternative embodiment of a blade holder in accordance with the principles of the present invention.

FIG. 9 is a top view of a mat in accordance with the principles of the present invention.

FIG. 10A is a front perspective view of the electronic cutter of FIG. 1 in an open configuration.

FIG. 10D is a perspective end view of the electronic cutter of FIG. 1A with the end-cap removed.

FIG. 10E is a semi-transparent perspective end view of the electronic cutter of FIG. 1A with the end-cap removed.

FIG. 10F is a semi-transparent perspective end view of the electronic cutter of FIG. 1A with the end-cap removed.

FIG. 10G is an end view of the electronic cutter of FIG. 1A with the end-cap removed.

FIG. 10L is a semi-transparent front perspective view of the electronic cutter of FIG. 1A.

FIG. 10M is an exploded perspective view of the electronic cutter of FIG. 1A with the end-cap removed.

FIG. 10P is a cross-sectional end-view of the electronic cutter of FIG. 1A.

FIG. 11A is a perspective front side view of an overlay in accordance with the principles of the present invention.

FIG. 11B is perspective bottom side view of the overlay shown in FIG. 11A.

FIG. 12 is an exploded perspective right side view of a cartridge in accordance with the principles of the present invention.

FIG. 13A is a top view describing the motion and orientation of portrait mode used by the electronic cutter of FIG. 1.

FIG. 13B is a top view describing the motion and orientation of landscape mode used by the electronic cutter of FIG. 1.

FIG. 14 is a schematic block diagram of a method of operating an electronic cutter in accordance with the principles of the present invention.

FIG. 15 is a schematic block diagram of a method of determining whether a cut will fit on a sheet in accordance with the principles of the present invention.

FIG. 16 is a top view of an input keypad for use with the electronic cutter of FIG. 1.

FIG. 17 is a top view showing the “flip” feature for use with the electronic cutter of FIG. 1.

FIG. 18 is a top view showing the “center point” feature for use with the electronic cutter of FIG. 1.

FIG. 19 is a top view showing the “line return” feature for use with the electronic cutter of FIG. 1.

### DETAILED DESCRIPTION

Referring now to the drawings, illustrative embodiments are shown in detail. Although the drawings represent the embodiments, the drawings are not necessarily to scale and certain features may be exaggerated to better illustrate and explain novel aspects of an embodiment. Further, the embodiments described herein are not intended to be exhaustive or otherwise limit or restrict the claims to the precise form and configuration shown in the drawings and disclosed in the following detailed description. This application claims priority to U.S. Provisional Patent Application No. 60/897,563 filed on Jan. 26, 2007, titled “Electronic Cutting Apparatus and Methods for Cutting”, to Workman et al., and this application is a continuation-in-part of application Ser. No. 11/457,415 filed Jul. 13, 2006, titled “Electronic Paper Cutting Apparatus”, to Workman et al., which claims priority to U.S. provisional application 60/699,210 filed on Jul. 14, 2005, titled “Electronic Cutting Apparatus and Methods for Cutting”, to Workman et al., all of which are incorporated herein by reference.

As discussed herein in detail, an example of an electronic cutting machine may include a cutting element for cutting a sheet of material, drive rollers for controlling movement of the sheet, and electronics for controlling movement of the cutting element and the drive rollers. The electronic cutting machine operates by moving the cutting element in an “x-direction” and the sheet in a “y-direction.” That is, when the cutting element is placed against the sheet, a controlled cut is made by moving the cutting element back and forth while the sheet is moved perpendicular to the movement of the cutting element. The cutting element is moveable in a “z-direction” to allow desired placement of the cutter against the medium being cut at a specific location and to lift the cuffing element when a particular cut is complete. By precisely controlling these two movements, a particular shape can be cut into the sheet.

The electronic cutter as described herein may be configured to operate as a stand-alone machine without any need for connection to a personal computer or other external device. All of the functions of the electronic cutting machine can be controlled by the user through a user interface provided on the electronic cutter.

In one example, various shapes to be cut with the electronic cutter are provided on a separate cartridge. When a user desires a particular image, a cartridge containing that image is connected to the machine. The user can then select the image to be cut using the user interface, such as a keypad, and instruct the machine to cut the image. The cartridge (e.g., containing an electronic memory that includes the shape's shapes description) is removable from the electronic cutter. Moreover, the cartridges may contain a library of shapes that the user may select for cutting.

In another example, the shapes for being cut are stored in memory on the machine. The user then uses the user interface to select a particular shape or series of shapes to be cut from the library of shapes stored on the machine.

In operation, a bottom door forms a support tray for the paper being cut while the upper door reveals the user interface when opened. The sheet to be cut is placed upon a mat having a tacky adhesive applied thereto for removably retaining the sheet. The mat and sheet are inserted into the machine and the blade holder is moved using the user interface over a select position on the mat. The desired shape is selected for cutting and the machine is instructed to cut the shape.

If desired by the user, each image or shape may be further customized before cutting. On example includes changing the size of an image to be cut. The image may be scaled by the user by selecting a desired shape of the image and rotating a sizing wheel until the desired size is displayed.

The cutting element is comprised of a blade holder and a blade. The blade holder allows the blade to freely swivel within the blade holder so that the blade will orient itself in the direction of the cut being made. The blade holder allows for the length of blade extending from the blade housing to be easily and precisely adjusted by a user. In addition, the blade housing is configured to precisely set the blade within the housing during the manufacturing process to ensure that each blade holder/blade assembly is properly configured.

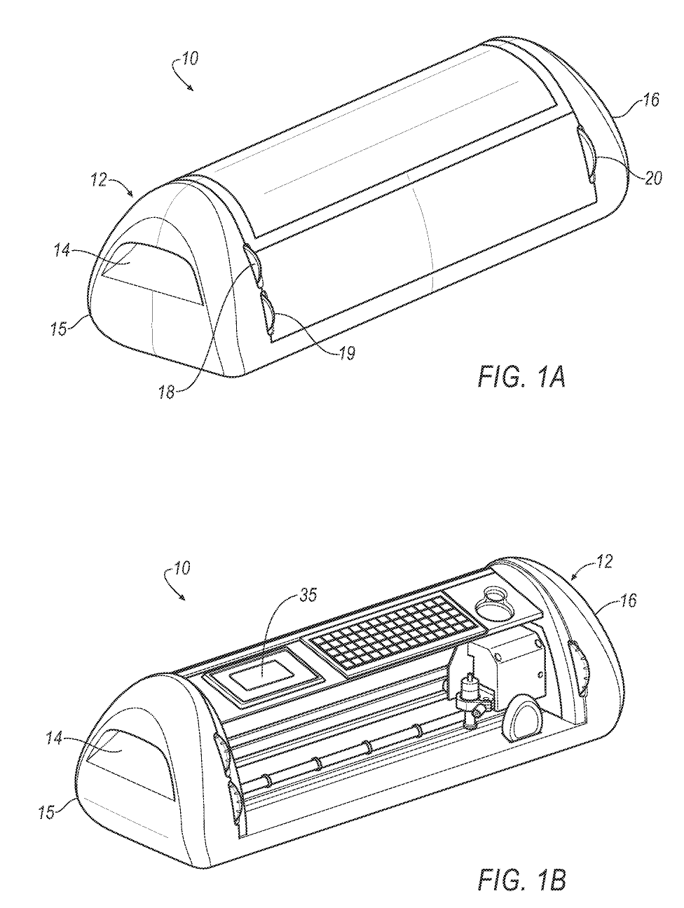

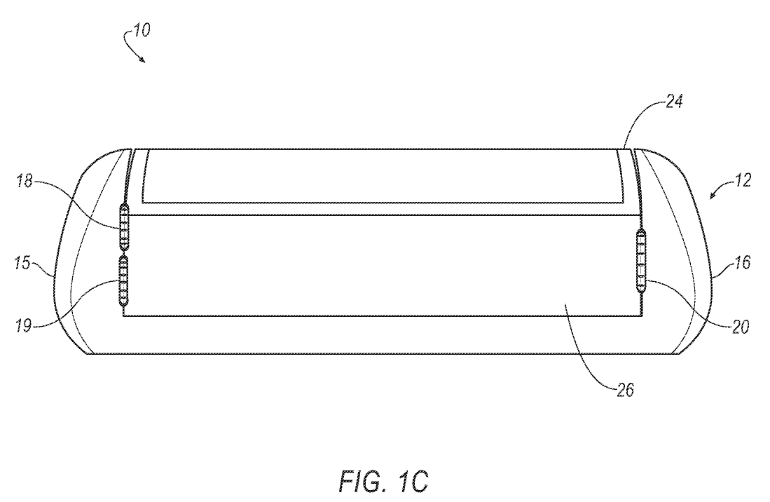

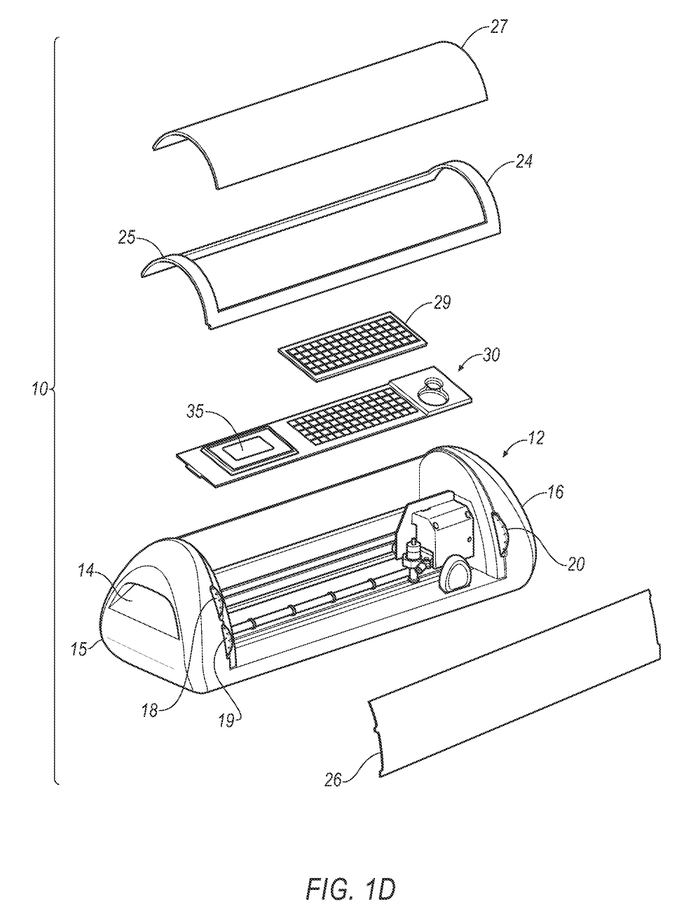

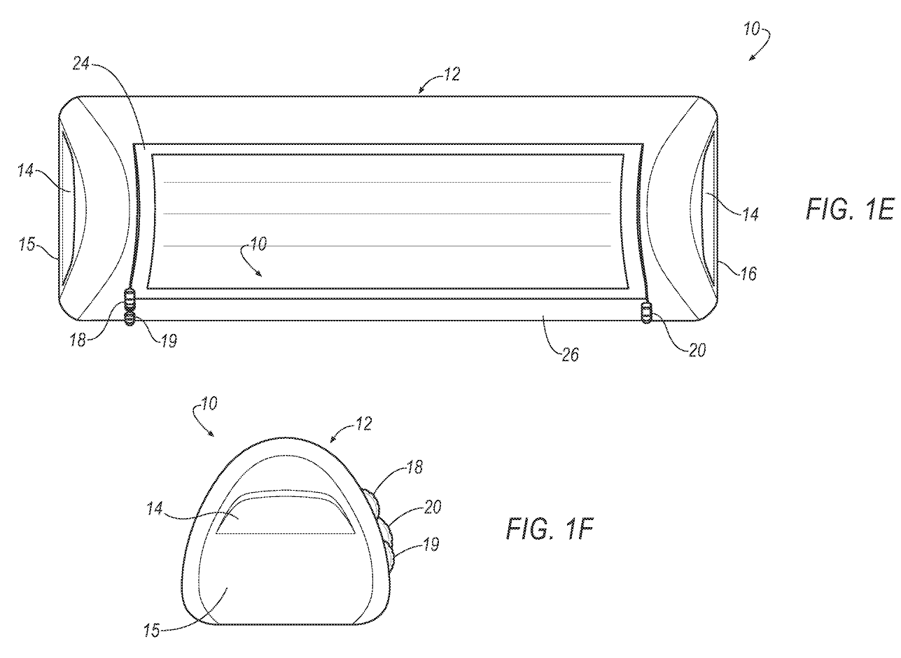

Referring now to the drawings, FIGS. 1A-1D illustrate an electronic cutter, generally indicated at 10. The electronic cutter 10 is a stand-alone machine that is fully functional without the need for connection to an external computer. All of the cutting components of the cutter 10 are housed within the external housing, generally indicated at 12, of the cutter 10. In addition, all of the software and electronics for driving the cutting components of the cutter 10 are housed within the external housing, as well as a removable and/or downloadable memory storage device for containing images, shapes, fonts and the like to be cut by the cutting components, so that the unit is fully operational and self contained. The housing is provided with recesses 14 on its left and right sides 15 and 16 for providing a place to grasp the sides 15 and 16 of the cutter 10 for lifting and carrying. In addition, rotatable wheels or dials 18, 19 and 20 protrude through the housing 12. The wheels 18, 19 and 20 are rotatable by a user to alter certain parameters of the cutter 10 such as the size of the image to be cut, the pressure of the blade when cutting, and the speed of cutting. As will be described in more detail, herein, the speed and pressure of the cutting process can be modified based upon the type of material being cut to prevent tearing of the material and/or to ensure that the blade is completely cutting through the material. Rotation of the dials 18, 19 and 20 will change parameters visible on the user display 35. For example, the dial 20 may be employed to modify the size of the image or shape to be cut. Thus, rotation of the dial 20 triggers a change in the image size shown in the display 35. The sizes may include in inches 1, 1¼, 1½, 2, 2½, 3, 3½, 4, 4½, 5 and 5½). Of course, other graphical representations could be used to display such information and will change depending upon the information linked to a particular dial. For a configuration where dial 20 is linked to image size when cut, when the dial 20 is set to a particular size, the cutter 10 will automatically adjust the size of the image or shape to be cut and subsequently cut an image of approximately the size indicated (in height) when instructed by the user to cut. Likewise, the dials 18 and 19 are electronically connected to the processor of the machine 10 to change and indicate in the display 35 to a user the pressure of the cut and the speed of the cut.

Display 35 may be used to display operating parameters, user selections, position information, general status, etc. Moreover, where space is not available on display 35 to show all information contemporaneously, scrolling text may be used to show a large amount of information. For example, where multiple characters are selected for cutting, a scrolling text display may be used to show the user the entire message that is selected for cutting. When the user desired to edit the message, the selected message may be scrolled from side-to-side using the direction keys and highlighting or underlining may be used to indicate the selected character.

Display 35 may also include the functionality to show the user's adjustments in real time for features such as cutting size, cutting speed, and cutting pressure. The user may “dial in” the desired setting based on the value shown in display 35. During the “dial in” process, display 35 may highlight the parameter being adjusted to draw the user's attention to it. For example, when cutting size is being adjusted, display 35 may highlight cutting size and non-highlight the other parameters. In this way, the user is immediately drawn to the parameter under adjustment. Other features of display 35 may include the presentation of warning and/or error message. If a warning or error is present, display 35 may switch the output to the warning/error and override the user's current operation. If desired, display 35 may also be used to present the user with questions, and keypad 40 may be used to receive the user's answer.

Each dial 18, 19 and 20, in an example, may be connected to a potentiometer or other device known in the art for sending a signal to the processor of the machine to change the corresponding parameter. Alternatively, dial 20 may be connected to a rotary encoder (e.g., an optical or mechanical encoder) to provide rotational positioning information to the processor (discussed below). With specific reference to the speed of the cut, in addition to manual adjustment of the speed through manipulation of one of the dials, the machine itself may be configured to automatically adjust the speed depending upon the pressure set by the user, which may indicate a thicker material being cut. In addition, for a given speed of cut, as may be set by the user, the machine will adjust the speed of the cut depending upon the curvature of the cut being made. For example, when cutting a straight line, the machine can move more rapidly through the material without causing a tear in the material. On tight corners, however, if the cut is moving too quickly, the material can be ripped. As such, the machine will automatically adjust its speed depending upon the radius of the arc being cut to prevent the material from ripping when cutting arcs of smaller radii. Thus, when cutting, the machine will automatically adjust “on-the-fly” the speed of the cut as the cut is being made.

Each of dials 18, 19 and 20 may be configured using a variety of technologies. For example, dial 20 may be configured as a potentiometer, an optical rotary encoder, a mechanical rotary encoder, a variable reluctance sensor, etc. For purposes of detecting the speed of the wheel, a variable reluctance-type sensor may be more advantageous than a potentiometer or rotary encoder. However, speed information may still be derived in firmware from the other sensor technologies (although not directly measured). Thus, depending upon the precision desired based on the user's rotation of each dial 18, 19, 20, a particular sensor technology may be more desirable than another may (although each may be used). The velocity-based detection methods for dials 18, 19, and 20 allow a user to quickly dial-in a precise setting. With large or rapid movement of the dial, very large changes in setting occur. However, as the user approaches the target value, the user slows the motion of the wheel, which provides for fine control. In this way, the user may rapidly modify setting without large numbers of rotations.

With particular reference to FIG. 1D, which is an exploded view of the machine 10, when the doors 24 and 26 are in a closed position as shown in FIG. 1C, the door 24 may be comprised of a frame member 25 and a clear or semi-translucent window 27 attached to the frame member 25. The use of such a translucent material, such as LEXAN, for the window 27 allows the user to view the user interface, generally indicated at 30, to determine the status as to whether the machine is “on” or “off.” As will be described in more detail, the user interface 30 comprises a keyboard interface assembly and includes the display 35 and function buttons 29. Alternatively, door 24 may comprise a single piece (e.g., combining frame member 25 and window 27) and may be made of a transparent, semi-translucent, or translucent material (e.g., plastic). The transparency/translucence of door 24 then allows the user to view the machine's on/off status.

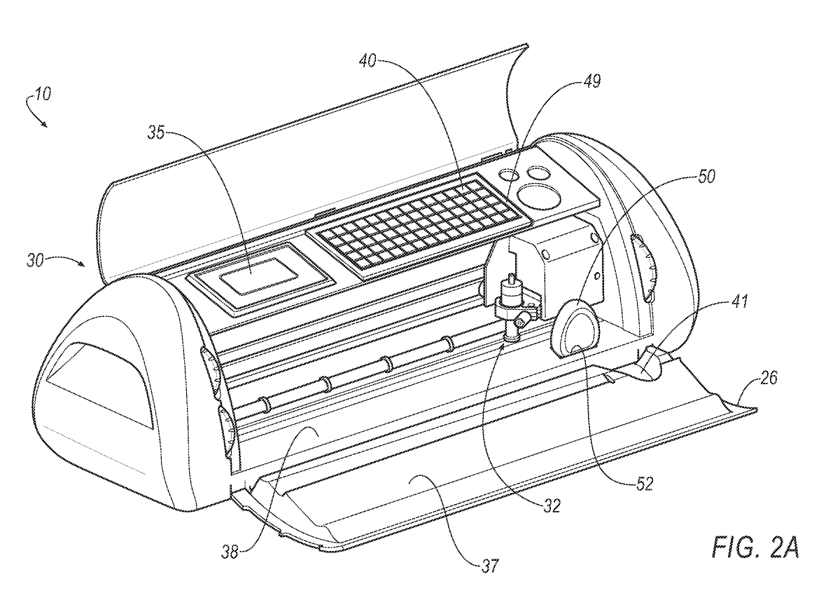

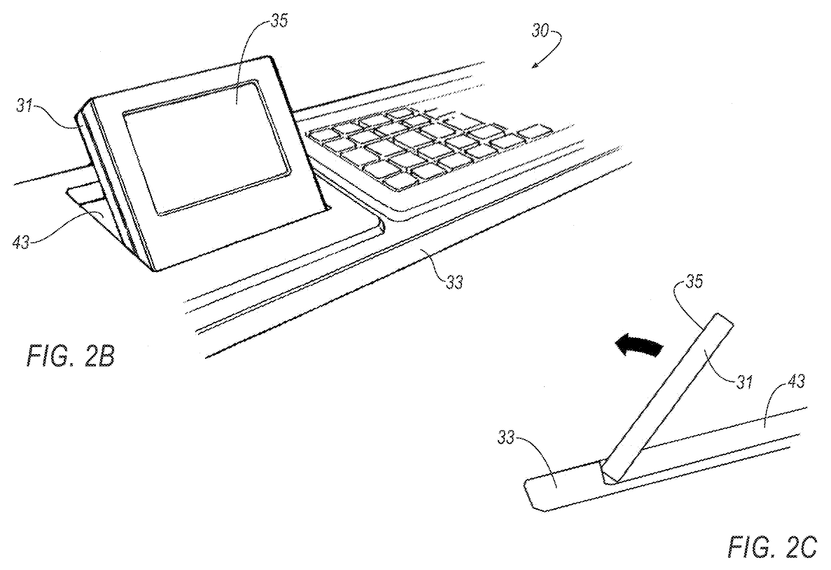

Referring now to FIG. 2A, the cutter 10 is illustrated in an open position in which the user interface, generally indicated at 30, and cutter assembly, generally indicated at 32, are shown. The user interface includes a visual display 35, such as an LCD display. Certain relevant data, such as the shape or shapes selected for being cut, the size of the shape, the status of the progress of a particular cut, error messages, etc. can be displayed on the display 35 so that the user can have visual feedback of the operation of the machine.

As further illustrated in FIGS. 2B and 2C, the user display, 35 may be mounted within a pivotable housing 31, pivotably mounted to the keyboard support structure 33 of the user interface 30. The display 35 can be positioned in a first flat position with the display 35 resting within the recess 43 or tilted to a position that is more easily readable by the user as illustrated. Thus, the LCD display may be tilted at an angle to improve the viewing angle for a user. The display 35 is also configured to be removable from the recess 43 for maintenance and repair in that the display 35 may be snapped out of its position and quickly disconnected from the main connector on the keypad PCB board (not shown).

Referring again to FIG. 2A, the back surface 37 of the bottom door 26 provides a support tray for the mat and material being cut by the cutter 10 so that the material and mat (not shown) remain in a substantially horizontal orientation when being cut. In addition, the inner bottom surfaces 38 of the cutter are also generally horizontal and planar in nature to support the material being cut in a substantially flat configuration. In some prior art machines that have been adapted from the vinyl sign cutting field to the paper-cutting field, the machines have generally retained a curved support surface. The curvature of the support surface was generally employed to accommodate the material being cut, namely adhesive backed vinyl, typically in a roll form. Such a configuration is not particularly conducive to cutting sheets of material such as paper and the like where bending can cause portions of the images being cut to lift from the planar surface defined by the sheet causing the blade or blade holder to catch any such raised portions that could damage the material of the shape being cut. The inner surface 37 of the door 26 may also be adapted to slide out, or may otherwise be strengthened to hold larger sized mats (e.g., mat 300) such as a 12″×24″ mat or greater. The inner surface 37 of the door 26 thus is effectively coplanar with the inner bottom surface or bed 38 of the cutter adjacent the drive roller 39. In addition, the inner surface 37 defines a recess 41 for accommodating the cartridge 50 when the door 26 is in a closed position as shown in FIG. 1A. This allows for a more compact configuration of the machine 10 with the cartridge 50 fitting within the door 26. Thus, the machine can be transported with the cartridge 50 positioned inside with the door 26 closed.

Similarly, as shown in FIG. 2B, the upper door assembly 24 is comprised of an outer shell section 24′, which forms a portion of the exterior surface of the cutter 10, and an inner section 24″, which houses the display 35. In this example, the display comprises a liquid crystal display (“LCD”) device that is visible through a window 51 formed in the inner section 24″. A transparent cover 53 is configured to be attached within a recess 55 formed in the inner surface 34 for protecting the screen 57 of the LCD 35. The wires (not shown) connecting the LCD 35 to the processor of the cutter 10 are extended through the arm 59 to protect and conceal the wiring.

Display 35 may be configured in size as appropriate to the size of electronic cutter 10 and the available space, as well as the number of features or parameters to display to the user on a single screen. Display 35 may also be implemented in a variety of technologies including LCD and OLED (Organic Light Emitting Diode) technologies, etc. One example of display 35 may include an LCD display having a size in the range of 2.7-2.9 inches diagonal, having 2:1 aspect ratio and a 128×64 resolution. Alternatively, display 35 may be configured as a multi-line character-based display (e.g., such as a 16×4 LCD module).

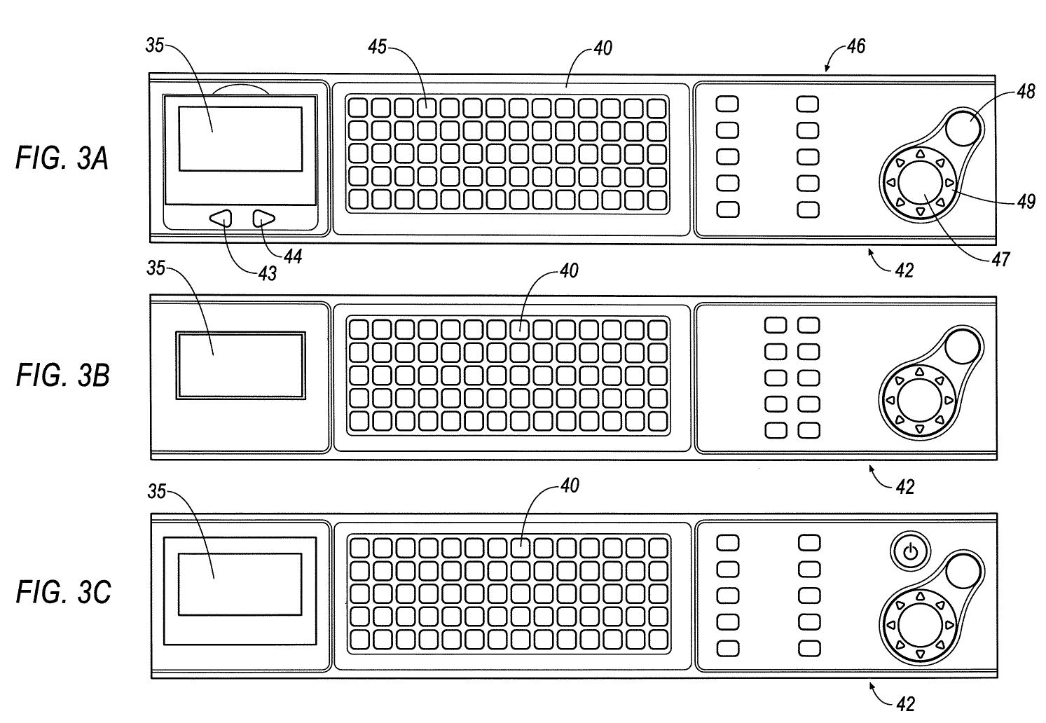

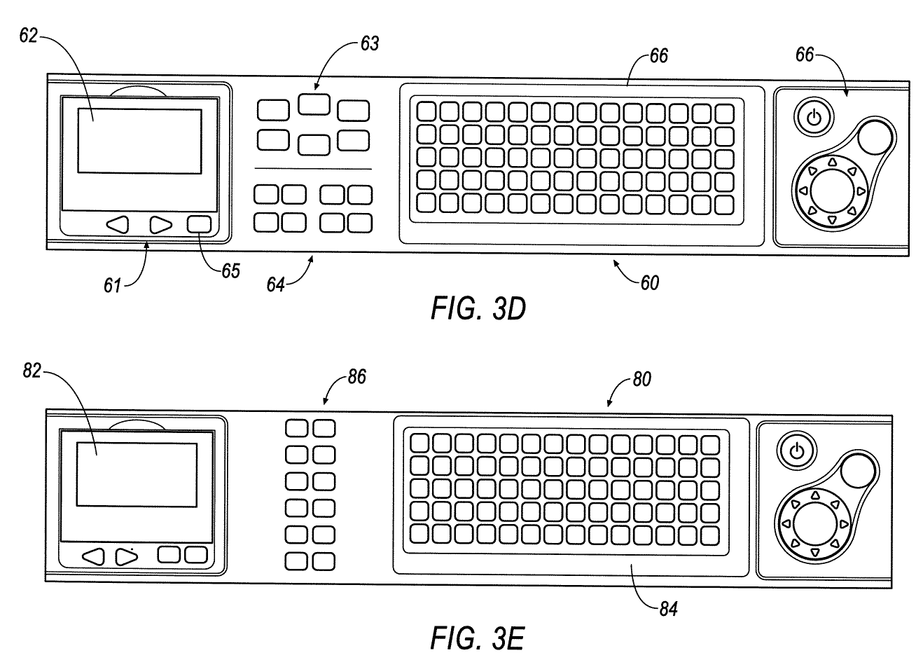

Referring now to FIGS. 3A-3C, a user interface 30 includes a keyboard 40, a plurality of buttons 42 and the display 35. Between the keypad 40 and buttons 42, a user can completely control the operation of the cutter. As such, there is no need to connect the cutter to an external controlling device such as a personal computer in order to cause the cutter 10 to cut a selected image. The user interface 30 includes the adjustable view LCD display 35 and cursor control buttons 43 and 44. A main keyboard overly 45 is provided over the keyboard 40. A 10 button feature layout 46 is provided to provide common function buttons, such as auto expand, auto fill, multiple out, quantity, center cut rotate, flip and other function buttons F1, F2 and F3. Of course, such buttons could be modified or additional buttons included. The button descriptions can be embossed or molded into the plastic. The start and stop buttons 47 and 48, respectively, may be backlighted with an LCD or LED. In addition, an eight-position controller 49 is provided. The arrows on the controller 49 indicate the ability to move the paper in the cutter and/or the cutter head in a direction pressed. The paper and/or cutter head then moves smoothly in the direction selected by the user. In alternative embodiments, eight-position controller 49 may be implemented as a single, joystick-like control pad, or a touch pad. Such an arrangement would allow for a finer degree of control than a four-position or eight-position controller 49.

Stop button 48 may be configured as part of keypad 40 in a matrix, or it may be hardwired to the controller. Stop button 48 in particular may be hardwired to the controller to allow for interrupt-based sensing of the user's key press, although any of the buttons may be hardwired to the controller. This may allow for reduced latency in stopping the cutter even though any delay may be unperceivable to the user (e.g., due to firmware execution on the processor).

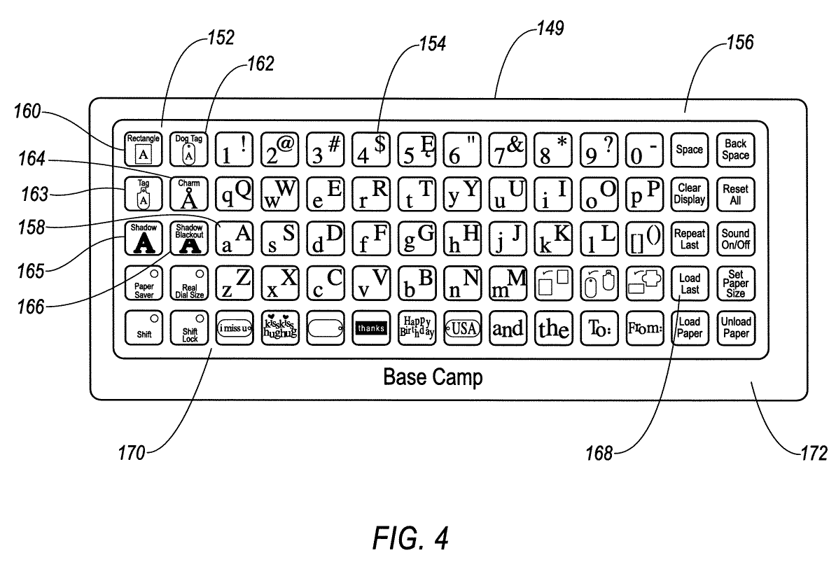

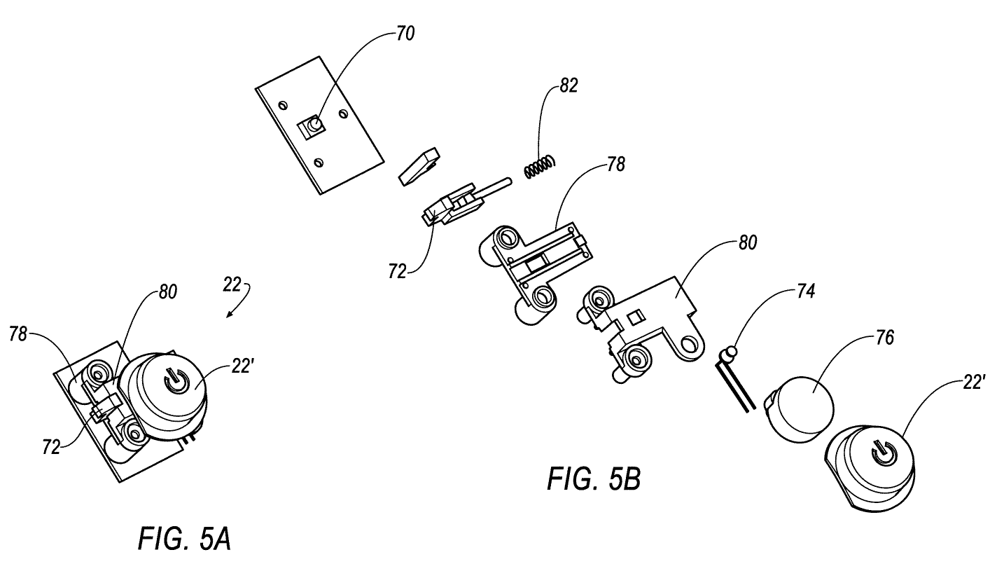

FIGS. 3D and 3E illustrate additional user interface configurations. The user interface 60 includes the display 62 and associated buttons 61, user mode buttons 63 and quantity control buttons 64, keypad 66 and cutter control buttons 68. The mode buttons 63 include buttons to allow the user to select certain features. For example, the “Mix 'n match” mode button allows each character to have a separate feature setting. When turned off, all entered characters through the keyboard 66 use the same creative feature setting. When the mode is selected, the character entered may have a separate creative feature for that character. This allows the user to enter a character and then choose a particular creative feature to be added to that character (such as one of the character features 152 shown in FIG. 4). The OK button 65 is provided to allow the user to proceed since the selection resets the environment back to only one feature selected.

The Auto Fill mode calculates how many copies of the selected characters can fit on the remainder of the page to be cut. The auto fill will turn off “Fit to Page” or “Quantity” when pressed. The display 62 will show how many copies will fit on the sheet prior to cutting.

The Fit to Page mode calculates the best and maximum size of the selected glyphs (images or letters) to be cut and sizes them up or down to fit on the remainder of the page. That is, if an image has already been cut by the machine on the sheet currently loaded, the fit to sheet feature will know how much of the sheet is left for cutting and adjust the sizes of the images to be cut to fit within the remaining space. As such, as with many of the other features or modes described herein, because the machine knows how much has already been cut from a sheet and where on that sheet such cutting has occurred, it can adjust any selected modes or features to be cut in the remaining paper. Thus, unlike a typical “fit to sheet” selection as may be found in printing programs to fit to a particular sheet of paper, the cutter adjusts the fitting on the fly as the usable size of the remaining sheet decreases with each successive cut.

The “Fit to Length” mode changes the parameters of the size dial, previously discussed, to become a selector for overall length of cut. Thus, the feature essentially becomes a Fit to Page cousin where the overall glyph(s) length is crunched down (e.g., reduced) to fit the dialed-in size selected. The range of the size would necessarily be limited by the page length left for cutting. Thus, the machine effectively ignores the current size setting when this feature is selected.

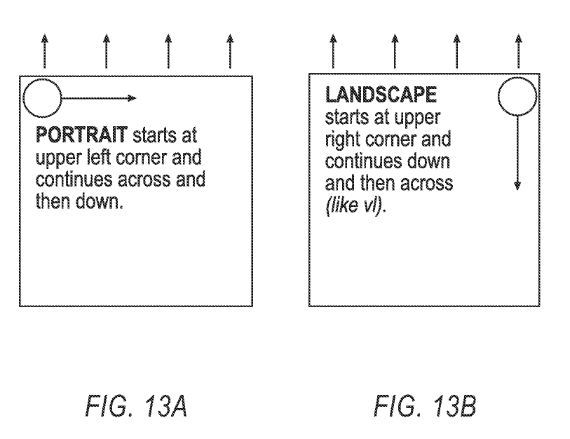

The “Portrait” mode changes the direction of the cutting from lengthwise to a left to right manner. This may require an OK button 65 confirmation since the machine would auto unload and restart the orientation of the entire cutting mat. The portrait feature allows for the orientation of the mat to be customized in a portrait (see FIG. 13A) vs. landscape (see FIG. 13B) mode.

The quantity mode when pressed activates cursor keys to increase/decrease the quantity count. The user can press the OK button 65 to set the quantity. The first time the CUT button is pressed, the display 62 will show “Quantity NNN will require XX pages. Press CUT to begin cutting the first page.” This informs the user that the quantity selected may require more than one sheet for cutting with NNN and XX representing numbers. After each page is cut, the display will show “YY more pages to cut. Load another page too continue cutting or press STOP to exit.” Thus, after each page, the user can decide to continue by inserting another sheet and pressing the CUT button or cease the cutting of the selected quantity by pressing the STOP button. Of course, there are certain functions that can be used in conjunction. For example, Quantity and Fit to Page or Fit to Length could be used together. The Quantity filed appears on the display 62 when the Quantity feature has been selected by the user.

The Flip mode button when selected causes the selected image to be cut as a “mirror” image of the selected glyph. This feature may apply individually to all selected glyphs.

The Multi Cut mode (also described below) would cause the machine to make multiple cuts of the same image two (2), three (3) or more times. The Multi-Cut feature could be used for thicker materials to ensure that the image is cut completely through the particular media.

The Center Point mode (also described below) allows a user to use the cursor keys surrounding the CUT button to position the blade as desired. When doing so, the machine will calculate whether the chosen position will allow the cut to proceed with the existing settings. If not, a “Cannot Fit” error will be displayed to indicate to the user that the position of the blade will not allow the image to fit on the sheet.

Various addition settings may also be selected. For example, in the Settings mode, one can toggle through various selections using the arrow keys to select choices on the same level. Pressing OK 65 will confirm the selection. Some settings may be language, Units, Multiple Cut or others. Other keys may be provided for future feature upgrades.

FIG. 3E illustrates another example of a user interface, generally indicated at 80. The user interface includes a display 82, a keyboard 84, and various user buttons, generally indicated at 86. The user interface buttons include various status buttons, such as Paper Saver, Real Dial, Auto Expand, Auto Fill, Multiple Cut, and Center Cut. Effects buttons, such as Flip and Rotate are also provided. The Setting buttons include Size Length, Language, Settings, sound, etc. The Edit buttons allow the editing of Glyphs, Quantity, Deletions, backspace, Space, etc. Finally, various Function buttons may include Clear Display, Reset All, Repeat Last, load Last, Set Paper Size, Load and Unload.

The Auto Expand feature allows the user to expand the image to the largest size possible. It may also be used in conjunction with the Quantity feature. The Auto Fill feature would automatically fill the page to be cut with the selected images. The Rotate feature would allow the user to rotate an image to be cut to a desired orientation. This may or may not require the user to reload the sheet to be cut.

As will be described in more detail, as illustrated in FIG. 2, the cutter 10 includes a memory storage device 50 for storing various shapes, such as fonts, images, phrases, etc., that can be cut by the cutter 10. In this example, the memory storage device 50 is in the form of a removable and replaceable cartridge. The cartridge is provided with a particular library or set of shapes that can be selected using the keyboard 40. When a new set of shapes is desired, the cartridge 50 can be removed form its socket 52 and replaced with another cartridge containing the desired shape or shapes. In combination with a change of the cartridge 50, the keyboard 40 is provided with a removable and replaceable overlay 49 that is formed of a flexible material such as silicon rubber, PVC or other rubber-type materials to allow the keys of the keyboard 40 to be pressed when the corresponding raised keys of the overlay are pressed. The overlay may be formed from a clear, transparent or translucent material to allow light from the keys of the keyboard 40 to be seen through the overlay 49. In order to identify which overlay corresponds to a particular cartridge, the particular name of the font or image set (as well as the individual characters, phrases and functions) can be printed, as by silk screening or other methods, onto the overlay and the same name printed on the cartridge or printed on a label that is attached to the cartridge. In addition, if desired, by matching the color of a particular keyboard overlay 49 with the color of a particular cartridge 50, a user can easily verify that they are using the correct cartridge 50/overlay 49 combination. For any given color or material from which the overlay is formed, the overlay is not completely opaque. Thus, as previously discussed, in order to signify to the user that a particular function key has been activated, such as CAPS or the like, an LED is positioned beneath the key to illuminate the key when activated. As such, by forming the overlay 49 from material that is at least partially translucent, the light from the LED is visible to the user through the overlay 49. Thus, both the keys of the keyboard and the overlay 49 are formed from an at least semi-translucent material.

Cartridges 50 may be used for various embodiments of electronic cutter 10. For example, where different versions of electronic cutter 10 are available, cartridge 50 may be backwards compatible with features of each electronic cutter 10. That is to say, if one embodiment of electronic cutter 10 supports certain features but another embodiment does not, the same cartridge 50 may be used or both electronic cutters 10. However, features not supported by electronic cutters are then not available. Such a system of backward compatibility allows consumers to purchase cartridges that are supported by a plurality of machines and substantially alleviates versioning problems.

As shown in FIG. 4, a particular keyboard overlay 149 is illustrated. The keyboard overlay provides a plurality of shape or image enhancement keys, generally indicated at 152, a plurality of image and font keys, generally indicated at 154 and a plurality of cutter control keys 156. The image and font keys 154 each provide a graphical representation of the fonts, characters and images that are available on a particular cartridge. In this example, for the character set entitled “Base Camp” shapes and a few pre-made phrases are provided. The image enhancement keys 152 provide various character-altering features that can be performed to a particular selected image. Thus, for example, by pressing and selecting the letter “A” 158, various modifications or enhancements can be selected by pressing one or possibly more of the enhancement keys 152. The enhancement keys can enhance the letter “A” by adding various components to the letter, such as by surrounding the letter by a rectangle 160, a dog tag 162, a tag 163, and a charm 164. Alternatively, the enhancement key may modify the letter “A” by putting it in the form of a shadow 165, or a shadow blackout 166. In addition, various other modes can be selected such as “paper saver”, “real dial size”, “shift” or “shift lock”. The cutter control keys 156 include such features as adding a space between characters typed by a user and “back space” when typing in a particular string of characters to remove the last character typed. Also, there are keys for clearing the display, resetting, repeating the last character, turning the sound feature of the machine on or off, setting the paper size, and loading or unloading the paper. It is also contemplated that all or a portion of these features can be selected by using the directional keys that surround the CUT button 44 (see FIG. 3) and selecting such features visually through the LCD display.

In addition, a “Load Last” key 168 is provided. The load last key 168 allows a user to reinsert a mat into the cutter after some material has been cut from the mat. That is, as will be described in more detail, as the machine cuts a particular image or set of images from a particular paper/mat combination, after the mat is removed to remove the shape that has been cut, a user has the option of reinserting the same mat with the remaining paper still attached thereto. By pressing the “Load Last” key, the cutter will have stored data to know the area of the mat that has already been cut. When the user selects a new character or shape to be cut, the cutter will automatically move the cutter head to an area of the paper that has not yet been cut. In addition, the cutter will know if the particular character or shape to be cut of a particularly selected size will fit in the remaining paper. If the character or shape selected by the user is too large to be cut from the remaining paper, the cutter will alert the user by a visual and/or audible alarm, such as a beep and a message on the display of the cutter that the image is too large.

Each key 152, 154 and 156 of the overlay 149 is raised above the base surface 170 with the back surface (not shown) of each key 152, 154 and 156 forming a recess for receiving therein a keyboard key. As such, when placed over the keyboard of the cutter, the overlay 149 will self-align so that it is properly positioned over the appropriate keys. The outer rim 172 of the overlay 149 also seats onto the keyboard to ensure that the overlay is properly positioned and that the overlay cannot be misaligned with the underlying keypad.

Referring again to FIG. 3A, the cursor button 49 provides control of the cutter assembly. That is, the button 49 with arrows can be used to cause movement of the cutter assembly 32 to a particular location on the mat (not shown). Thus, the user can selectively control the position of the blade by using the four arrow buttons to move the blade to a specific location over the material to be cut. This is especially helpful if the user is cutting on an odd shaped piece of paper or on a sheet of paper where a selected cut is desired at a specific location. Thus, the user can selectively choose the location on the sheet where a selected cut will begin. Once properly positioned and the desired image selected with the user interface 30, the cutter 10 is instructed to cut the selected shape by pressing the CUT or Start button 47. If necessary, during a particular cutting sequence the cutting process needs to be halted, a user can press the stop button 48 located proximate the Start button 49.

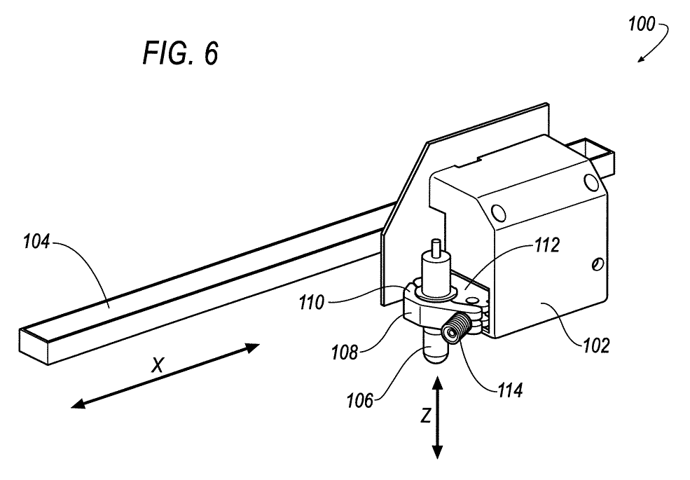

Referring now to FIG. 6 is a cutter assembly, generally indicated at 100. The cutter head unit 102 moves from side-to-side relative to the cutter 10 in the X direction, as shown by arrow X. Movement of the head unit 102 is controlled by a stepper motor (not visible) housed within the head unit 102 to move the head unit 102 along the rail 104. Coupled to the head unit is the blade holder 106 that retains a blade (not visible) for cutting the desired material. The blade holder is removably coupled to the head unit 102 with a releasable clamp mechanism 108 comprised of a first pivotable clamp portion 110 pivotably coupled to a second stationary clamp portion 112. The two are releasably held together with threaded fastener 114. The clamp mechanism 108 prevents vertical movement of the blade holder 106 relative thereto by engaging with the blade holder in a vertically abutting manner. The blade holder 106 is configured to be easily removable by a user so that the user can replace the blade when it becomes too dull to properly cut or to adjust the amount of the blade that extends from the blade holder to accommodate materials of different thicknesses.

In addition to coupling and supporting the blade holder 106, the head unit 102 houses a solenoid (not visible) that is coupled to the clamp portion 112 that supports the blade holder 106. The solenoid controls the amount of pressure that the blade applies when cutting. The solenoid also controls the vertical movement of the blade holder 106 when lifting the blade, in the Z direction, away from the material to allow the blade to move to a new cutting position without cutting. The user can adjust the pressure applied by the solenoid to the blade with one of the dials shown in FIG. 1. Such pressure adjustment may be required to properly cut a given material. For example, a pressure setting to cut a sheet of regular paper may not be adequate to cause a proper cut into thick card stock. As such, the pressure may need to be increased. Conversely, the pressure necessary to cut through thick card stock may cause the blade to tear a regular sheet of paper if a cut is attempted at too high of a pressure setting.

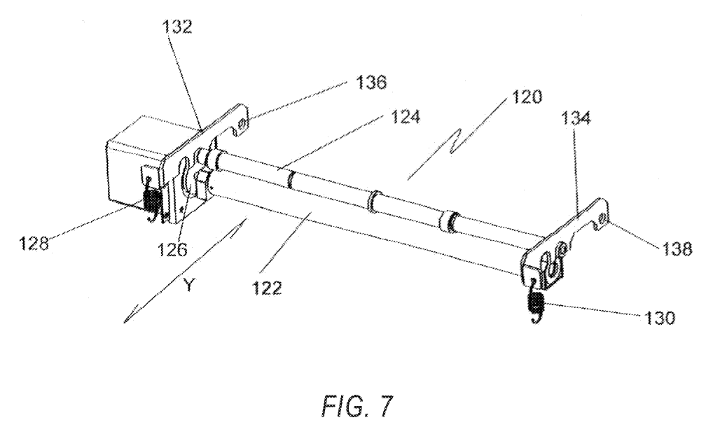

As shown in FIG. 7, a roller assembly, generally indicated at 120, is used in combination with movement of the blade holder to cause a cut of a particular shape and size. The roller assembly 120 is comprised of a pair of rollers 122 and 124 that engage the material being cut to move the material in a Y direction that is substantially perpendicular to the X direction shown in FIG. 6. The material being cut is fed through and between the rollers 122 and 124 such that during a cutting sequence the rollers 122 and 124 can control the Y position of the material, as indicated by arrow Y. The roller 122 constitutes the drive roller as it is driven by a stepper motor 126 with the shaft of the motor coupled to the drive roller 122. The drive roller 122 may have a texture applied thereto to cause a gripping action between the roller 122 and the material being cut or the mat to which the material being cut is temporarily attached. The biasing roller 124 maintains the material (and mat) being driven by the drive roller 122 in contact with the drive roller 122 as the drive roller 122 rotates. The biasing roller 124 is biased by springs 128 and 130 relative to and toward the drive roller 122. This biasing feature allows the two rollers 122 and 124 to accept materials of different thicknesses to be inserted between the rollers 122 and 124. The roller 124 is thus rotatably attached to pivoting mounting brackets 132 and 134 that pivot about apertures 136 and 138 that are pivotably coupled to the machine with the springs 128 and 130 allowing biased pivotal movement of the mounting brackets 132 and 134.

The processor of the machine controls movement of the stepper motors that control the drive roller 122 and the cutter head 102 to coordinate movement of the material being cut and the blade in a manner that produces a programmed cut. Because the rotational movement of the stepper motors can be precisely controlled, a precise cut can be made.

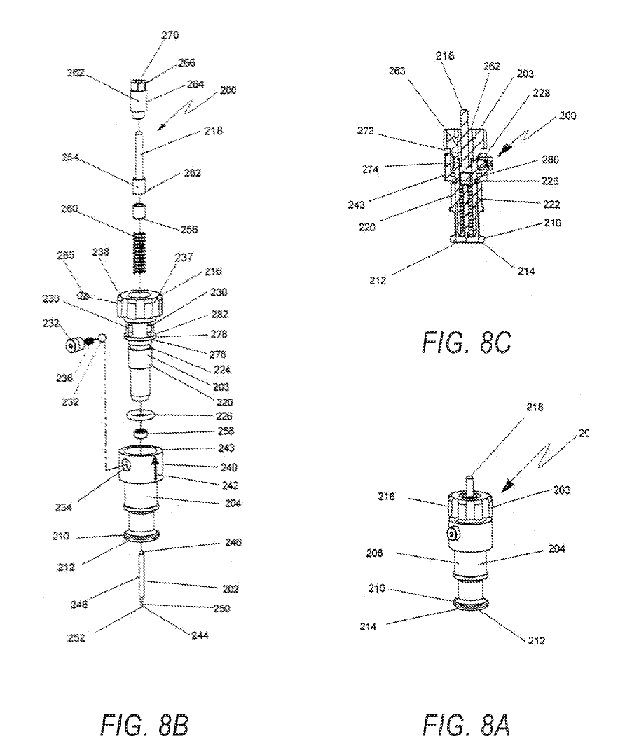

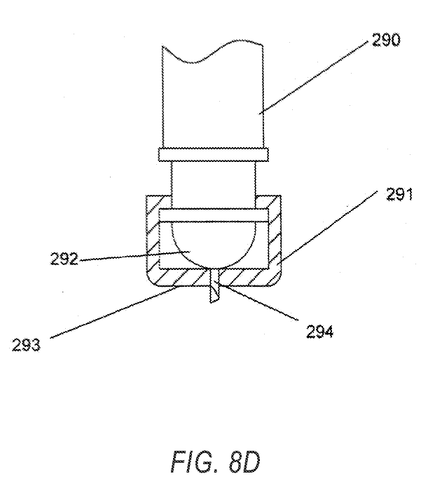

A blade housing, generally indicated at 200, is illustrated in FIGS. 8A, 8B and 8C. The blade housing 200 supports and retains the blade 202 therein relative to the cutting machine and also provides the capability for factory adjustment of the blade 202 relative to the inner housing 203 as well as easy and controlled blade adjustment of the blade 202 relative to the outer housing 204 to allow the user to adjust the depth of cut.

The blade holder 200 is configured to be held in the head assembly of the cutter. A circumferential channel 206 is provided in the outer housing 204 for retaining the blade holder. The distal end 210 of the outer housing 204 defines a relatively flat bottom surface 212 over a substantial portion thereof. The use of a flat-nosed end 210 is a substantial improvement over the generally curved ends of prior art blade holders. In particular, the flat nosed end 210 holds the material being cut while the blade moves through the material. The flat-nosed end 210 also includes a radiused lower edge 214 that transitions into the flat surface 212. Of course, the lower edge 214 could be formed from a bevel as well. The bottom surface 212 has sufficient surface area to allow the lower surface to ride on and glide along the material being cut without catching and lifting any of the material already cut. In addition, as the blade 202 cuts through the material, the lower surface 212 holds the material around the blade to allow the blade 202 to cut the material without tearing it. As shown in FIG. 8D, it is also contemplated that a rounded end prior art cutter 290 configuration could be employed with a generally flat foot 291 secured relative to the rounded end 292, somewhat similar to a foot on a sewing machine that surrounds the needle, to form a flat surface 293 through which the blade 294 would extend in a similar manner to the flat nosed end 210. Thus, while the flat-nosed end 210 of the present end is illustrated as being an integral component of the outer housing 204, it is also contemplated that it could be a separate component attached thereto.

The blade housing 200 also allows adjustment of the blade 202 relative to the outer housing 204. This is accomplished by rotating the inner housing 203 relative to the outer housing 204 by grasping and turning a blade height adjustment knob 216 that is integrally formed with the inner housing 203. The engagement of the inner housing 203 with the outer housing 204 is such that the amount of relative rotation between the two is limited in both directions. In the example shown in FIG. 8A, the adjustment knob 216 can rotate relative to the outer housing approximately one full revolution to adjust the blade 202 from its minimum amount of protrusion beyond the bottom surface 212 to its maximum. In order to accomplish such a rotational adjustability, the inner and outer housings 203 and 204 are in threaded engagement with the pitch of the threads determining the relative movement of the two for any given amount of relative rotation. For example, one-quarter turn could adjust the blade approximately 0.5 mm. By having four set points in 360 degrees of rotation, the blade's depth of cut could be increased a total of 2 mm in one full revolution of the adjustment knob 216. Of course, more or less set points could be provided to provide various levels of adjustability.

A plunger 218 extends from the adjustment knob 216 to force the blade 202 out of the distal end 210 of the housing 200 a sufficient amount to be grasped by a user. The blade 202 can then be pulled from the housing 200 and removed. Replacement of the blade 200 is accomplished by inserting another blade 202 into the housing 200. No other adjustment is necessary.

As shown in FIGS. 8B and 8C, the housing 200 is comprised of the inner and outer housings 203 and 204. The inner housing has an externally threaded portion 220 for mating with and threadedly engaging internal threads 222 formed on the inside of the outer housing 203. An o-ring 226 is interposed between the inner and outer housings 203 and 204 and is seated within the circumferential channel 224 of the inner housing. The o-ring provides rotational resistance between the inner and outer housings 203 and 204.

In order to provide discrete set points of rotation between the inner and outer housings 203 and 204, a snap bearing 228 is biased into engagement with a plurality of detents or recesses 230 formed in the outer surface of the inner housing 203. The snap bearing 228 is a metal sphere having a radius that is greater than the depth of the plurality of recesses 230. The radius of the recess 230 is configured to be substantially similar to the radius of the bearing 228. An externally threaded bearing housing 232 is configured to threadedly engage with threads in the side bore 234 of the outer housing 204. A coil spring 236 is interposed between the bearing housing 232 and the snap bearing 228 to bias the snap bearing 228 into the recess 230. As such, as the inner housing is rotated, the bearing 228 will “snap” into a particular recess 230 when the recess 230 is properly aligned with the bearing 228. As such, when engaged with the recess 230, the bearing 228 will hold the relative positions of the inner and outer housings 203 and 204 at particular selected discrete set points. Thus, the depth of cut of the blade 202 can be precisely controlled for a given set point with the engagement of the bearing 228 to the recess 230. In order to provide a visual indicator of the position of the inner and outer housings 203 and 204, and thus, the position of the blade 202, the adjustment knob 216 is color coded with a particular color of paint or other suitable material coating the vertical channels 237 and 238 that are circumferentially aligned with a particular recess 230. Likewise, other indications may be provided on the adjustment knob to provide an indication of the relative position between the inner and outer housing. The upper portion 240 of the outer housing 204 is provided with an alignment mark 242 on the outside thereof. By aligning the mark 242 with a particularly colored channel 237, the amount of the blade 202 extending from the end 210 of the outer housing 204 will be precisely set. Alternatively, a vertical marker 243 constituting a vertically oriented channel may be formed in the upper portion 240. Again, the vertical marker 243 is aligned with one of the recesses 230. Furthermore, numbers may be printed or formed on the raised portions of the adjustment knob to which the alignment mark 242 can be positioned.

The blade 202 is provided with a sharp cutting end 244 at its distal end and a conically shaped proximal end 246. The body 248 of the blade is cylindrical in shape to provide stable and controlled, but free rotation of the blade 202 relative to the inner housing 203. The cutting end 244 is tapered to provide a leading edge 250 and a trailing edge 252. As such, the blade 202 can freely swivel within the housing 203 and will self-orient with the leading edge 250 oriented in the direction of the cut.

The blade 202 is releasably coupled to the inner housing 203 by magnetic force supplied by the magnetic blade stop 254. The blade stop 254 provides a bearing surface for engaging the conical end 246 of the blade 202 to allow free rotation of the blade 202 while retaining the blade 202 with the magnetic force. The longitudinal axis of the body 248 of the blade 202 is linearly and concentrically aligned with the longitudinal axis of the housing 203 with blade bearing 258 positioned adjacent the distal end of the housing 203.

In order to decouple the blade 202 from the housing 203, a plunger 218 is provided. The plunger 218 is longitudinally moveable relative to the housing 203 and is biased toward the proximal end of the housing 203 with the coil spring 260. The distal end 262 of the plunger 218 provides an abutment for the magnetic blade stop 254. Thus the position of the distal end 262 relative to the housing 203 determines the position of the blade 202 relative to the housing 203 and the longitudinal position of the housing 203 relative to the outer housing 204 determines the length of the distal end 244 of the blade 202 extending from the surface 212 of the flat nosed end 210.

In order to ensure that the position of the blade end 244 relative to the housing 203 is properly set at the factory, given the fact that variations in component dimensions due to factory tolerances could result in variations in the blade end 244 position relative to the end 212 for a given set point, a factory adjustment member 262 is provided. The member 262 is provided with an externally threaded portion 264 for engaging with threads on the inside surface 266 of the housing 203. The top portion 266 of the member is provided with a hex head for being turnable with a socket having a similar size. The member forms a sleeve around the plunger 218 to allow the plunger 218 to slide relative thereto. By threading the member 262 into the housing 203, distal end 262 of the plunger 218, which is wider than the longitudinal bore 270 of the member 262, is forced into the top end of the housing 203 a distance equivalent to the distance into the housing 203 that the member 262 is threaded. As such, at the factory, the member 262 can be threaded into the housing 203 until the blade end 244 is coplanar with the surface 212 of the housing 204. The setscrew 265 can then be threaded into the side of the housing 203 through the knob 216 to hold the set position of the member 262 relative to the housing 203. Thus, each blade 202 can be properly longitudinally positioned with the housings 203 and 204 so that adjustment by rotation of the knob 216 will cause the same displacement of the blade for each blade housing 200.

As shown in FIG. 8C, the housing 203 includes an internal bore 272 having two different diameters. The interface between the upper larger diameter portion and lower smaller diameter portion provides an abutment for engagement with the adjustment member 262, which is the maximum insertion of the adjustment member 262 relative to the housing 203. As illustrated, a small gap between the adjustment member 262 and interface is shown.

When the blade holder 200 is fully assembled as shown in FIG. 8C, the relative adjustment of the first inner and second outer housings 203 and 204 is limited in both directions such that a limited number of adjustment positions is provided. The number of “snap” positions, in this example, is limited to four as a result of the limitation of one full rotation of relative movement between the first and second housings 203 and 204. Of course, more “snap” positions could be provided by increasing the number of detents in the inner housing. As the first and second housings 203 and 204 are rotated into closer engagement, rotation is stopped by the bottom surface 276 of the circumferential raised portion 278 (see FIG. 8B) abutting the inside surface 280 of the housing 204. In the opposite direction, as the first and second housings 203 and 204 are rotated away from each other, the ball housing 232 extends through the sidewall of the housing 204 and protrudes therein to provide an abutment. As such, the top surface 282 of the protrusion 278 will abut the ball housing 232 to prevent further relative rotation of the first and second housings 203 and 204.

In addition to holding cutting blades, blade holder 200 may also accept embossing tools and writing tools. For example, blade holder 200 may accept an embossing tool having a round or blunt end that, rather than cutting, can trace a pattern onto the sheet material. Blade holder 200 may also accept a writing instrument such as a pen or pencil that allows for writing upon the surface of the sheet material. When used in combination, blade holder 200 provides for writing and cutting of sheet material. In this way, the user may cut out objects or shapes as well as placing designs thereupon with the writing instrument.

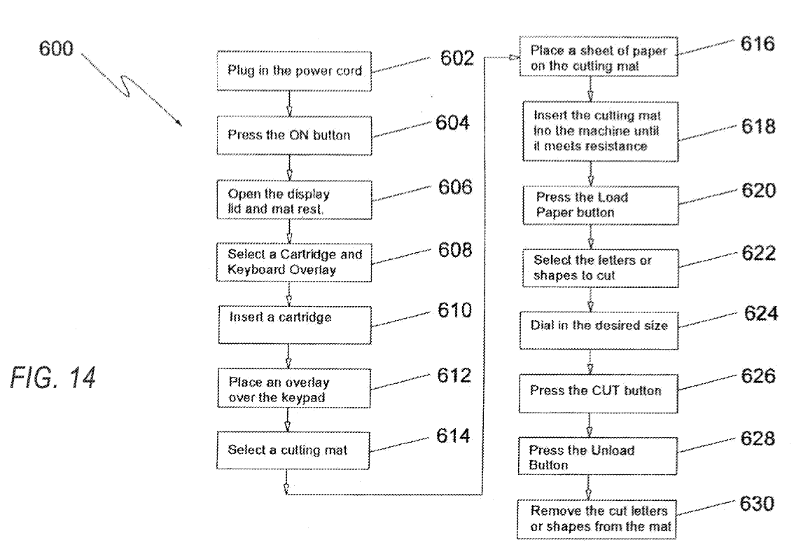

In operation, the cutter as illustrated in FIGS. 1, 2 and 4 is simple to operate. FIG. 14 is a schematic illustration of a method, generally indicated at 600, of operation of an electronic cutting machine. Since the cutter is an electronic appliance, a user power cord is plugged in 602. By pressing 604 the ON button 22, the machine power is turned on and the doors 24 and 26 open. The user may need to open 606 the display lid and mat rest. A particular cartridge 50 and keyboard overlay 49 are selected 608. The cartridge 50 is inserted 610 into the socket 52 and the corresponding keyboard overlay 49 is placed 612 over the keyboard 40. The overlay 49 indicates the specific content and features of the letter or image set contained on the corresponding cartridge 50. The user then selects 614 the cutting mat and places 616 a sheet of paper on the cutting mat.

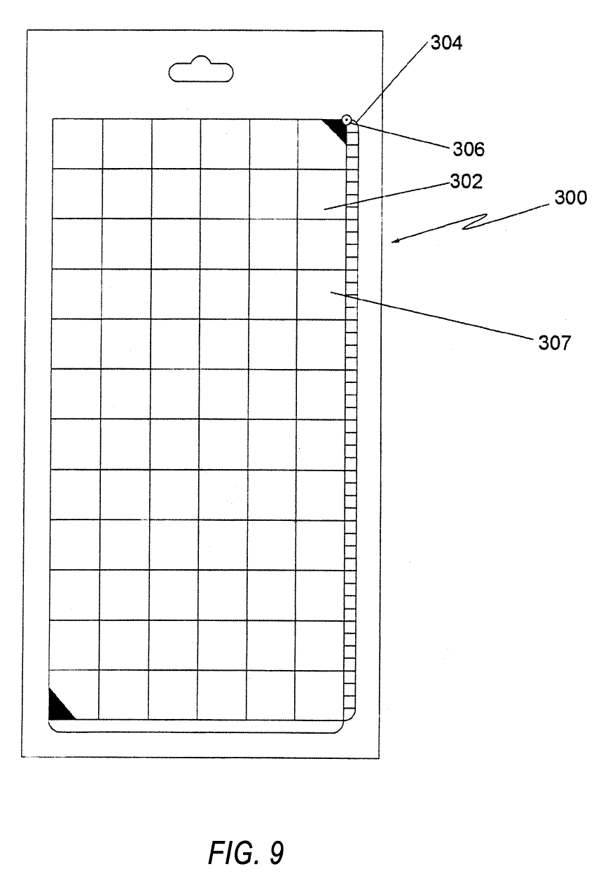

As shown in FIG. 9, a cutting mat 300 is employed to hold the paper or other material in sheet form to be cut with the cutter 10. The mat 300 is configured to hold a sheet of paper that is six inches wide and twelve inches long. The gridded surface portion 302 of the mat 300 is coated with a layer 307 of releasable adhesive that can hold the paper thereto while being cut, but will not permanently bond to the paper to allow the paper to be removed from the mat. The grid lines on the gridded surface portion 302 provide alignment features for positioning of a sheet of paper thereon. By only coating the portion of the mat with adhesive where the paper to be cut is applied, adhesive from the mat is not transferred from the mat to the components of the cutter rollers as the mat is moved by the cutting machine. Essentially, the mat 300 includes a “tacky” surface that will allow multiple uses before the adhesive looses its effective bonding capability. In the upper right hand corner 304 of the mat 300 is a blade alignment indicator mark 306. The mat 300 with a six by twelve inch sheet of paper attached thereto is fed into the cutter 10.

As shown in FIG. 9, cutting mat 300 may be embodied as a rectangular sheet, for example a six inch by twelve inch sheet (6″×12″). The cutting mat 300 may be inserted in portrait or landscape mode for cutting. Other sheet sizes are also available such as a 12″×12″, 12″×24″, etc. In general, a user may select the size of the cutting mat 300 via the user interface 30. Alternatively, electronic cutter 10 may automatically detect the size of the cutting mat 300. An example of automatic detection may include an optical reader that detects the edges of mat 300 (or fiducials) to detect the size. Another alternative may include an optical reader that detects a bar code on cutting mat 300. Such optical reader systems may also be used to detect the size of the paper (or other cutting material) applied to cutting mat 300.

Again referring to FIG. 14, much like inserting a sheet of paper into a typical printer, the mat is inserted 618 into the machine between the rollers until it meets resistance. When the “Load Paper” button on the overlay 49 is pressed 620, the mat is automatically fed into the machine and the blade will move to the upper right hand corner 304 of the mat. Thus, the machine is capable of automatically loading the paper to be cut by pressing a single button that loads the paper and moves the blade to the starting point. As such, the machine knows precisely where it is at relative to the paper to be cut. As discussed herein, the arrow buttons can also be selected to adjust the position of the blade if necessary. The letters or shapes to be cut are selected 622 by typing them out on the keyboard 40. The characters and/or shapes will be displayed on the LCD display 35. Once the desired characters and/or shapes have been selected 622, the user can dial in 624 the desired size of the images to be cut. The user then presses 626 the “CUT” button and the cutter will begin cutting the selected images. When the cutting process is complete, the blade housing will return to the starting point and the user can press 628 the unload button and the machine will eject the cutting mat. The images that have been cut can then be removed 630 from the cutting mat.

In order to modify the characters printed on the keyboard overlay, as previously discussed, certain functions are provided to allow for customization of the images to be cut. The “Shift” button can be used to select the upper character key (shown in gray in FIG. 4) (e.g., the upper case of a particular letter), while the “Caps” button will lock the keyboard to select all upper gray characters when the corresponding key is pressed. Similar to a typical computer keyboard, “Back Space” deletes the last entered selection and “Space” inserts a space between characters. The “Clear Display” key clears the LCD display and the “Reset All” key button resets the machine to clear any previous selections including selected character features from keys 152. If multiple cuts of the same character or selected characters are desired to be repeated, the “Repeat Last” key can be selected. In addition, the paper size may be modified if one is not using a six by twelve inch sheet.

As previously discussed, a user can easily modify the size of the character being cut by dialing the desired size with the appropriate dial. In order to keep the size of letters of a particular font consistent, the size is automatically adjusted in proportion to the largest possible character contained in the given font set. If one desires to deviate from this proportional scaling of sizes, the “Real Dial Sizing” key may be selected to cause the size of the particular character to be equal to the selected size. For example, if the letter “a” were selected to be cut, without “Real Dial Sizing” being selected, the letter “a” (small) would be proportionately sized to match the font size of “A” (capital). If “Real Dial Sizing” were selected, the letter “a” would be cut the same size as the letter “A”. When all of the desired characters or images are selected, the user will press the “Cut” button and the cutter 10 will cut the shapes. The feature buttons 52, allow custom feature effects for each set. Such features can vary with each specific cartridge to add various elements of expansion and versatility. For a given feature to be selected, the user need only press the desired feature button after selecting a desired character or image to which the feature will apply. Thus, the character may be modified as shown on a particular overlay by pressing the button on the overlay that corresponds to the desired feature.

In order to decrease the memory required to store a particular font, character, shape and/or image set on a given cartridge and thus decrease the cost of each cartridge, the images and fonts are stored as algorithms. As such, by storing a single algorithm for each character, image or feature, sizing is a simple matter of applying a multiplying factor to the particular algorithm that represents that character, feature or image. As such, there is no need to store separate images of each size on the cartridge. Thus, the ability to modify the size of a character with an added feature is a simple scaling of the algorithm for that feature/character combination and again does not require storage of each feature/character combination with a different feature added thereto (e.g., outlining, shading, underlining, etc.). As such, the fonts, characters and images stored on the cartridges may be resolution independent with the algorithms representing a series of straight lines and/or curves in a particular sequence. For higher resolution images, more individual line or curve segments are included.

The blade adjustment arrow keys that surround the CUT button allow the user to move the blade to any desired location on the mat. Such blade adjustment is often needed to allow the cutter to cut an image at a desired location on a given sheet of paper. The machine, however, is quite sophisticated in its ability to not only know if a particularly selected character and size will fit on a selected size of paper, but knows what it has cut from a particular sheet of paper and whether a newly selected shape for being cut will fit on the remaining paper. For example, when a user cuts a first image from a sheet of paper attached to the mat, the user can press the Unload Paper key and remove the shape that has been cut. The mat can then be reloaded back into the machine for additional cutting with the paper that is remaining by pressing the Load Last key 168. The user would thus press the Load Last key 168, select a new shape to cut and press the CUT button. Until reset, the machine will store in memory the shapes that have previously been cut and their location on the mat. When the user selects a new character or shape to be cut and presses the Load Last key 168, the cutter will automatically move the cutter head to an area of the paper that has not yet been cut for cutting the next shape. In addition, the cutter will know if the particular character or shape to be cut of a particularly selected size will fit in the remaining paper. If the character or shape selected by the user is too large to be cut from the remaining paper, the cutter will alert the user by a visual and/or audible alarm, such as a beep and a message on the display of the cutter that the image is too large. The user will then have the option of downsizing the character to fit or replacing the paper on the mat to accommodate a cut of the desired size.

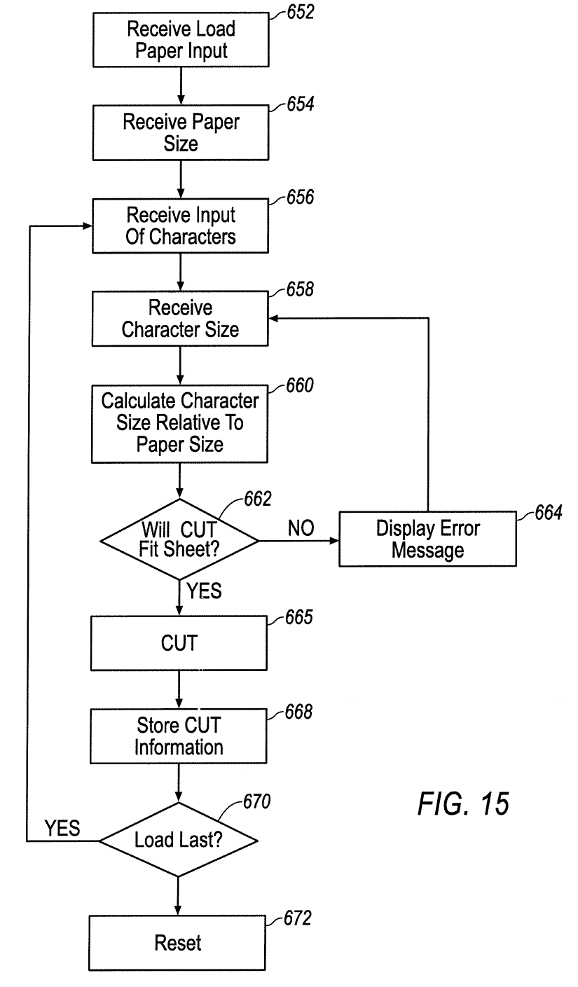

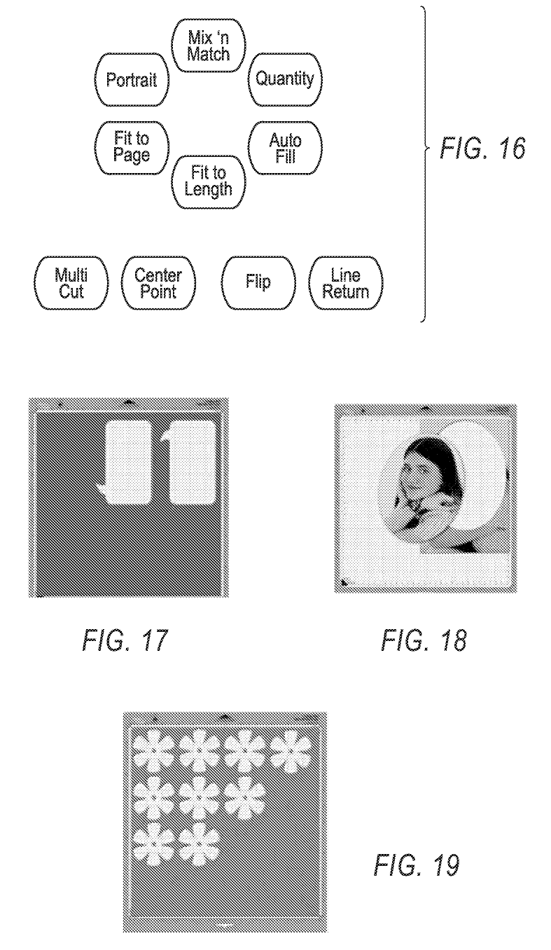

As shown in FIG. 15, the machine is capable of determining whether a particular selected character, image or series of characters and images will fit on the paper to be cut or the remaining paper after a cut has already been performed. As shown in FIG. 15, a method, generally indicated at 650 of determining whether a selected cut will fit is illustrated. Initially, the machine will receive 652 a Load Paper input from the user, after which the paper is loaded into the machine. Next, the user may input the size of the paper being cut and the machine will receive 654 this information. Alternatively, the paper size will be the default size of, for example, six inches by twelve inches. The user will then input and the machine will receive 656 the characters, images or other shapes to be cut using the user interface keyboard as previously discussed. The user will then select and the machine will receive 658 the size of the image(s) to be cut. The machine will then calculate 660 the selected character(s) or shape(s) size(s) relative to the size of the paper or remaining paper. When the user presses the CUT button, the machine will determine 662 whether the selected cut will fit on the sheet. If not, the machine will display 664 an error message and/or sound an alert and wait to receive 658 an acceptable size of selected characters or images. If the size of selected images will fit on the paper or remaining paper, the machine will cut 665 the image(s). The machine then stores 668 the CUT information of the image(s) that have been cut. After the user has removed the cutting mat by pressing the “Unload Paper” button and removed the cut image(s) from the cutting mat, the user can reinsert the cutting mat with the remaining paper on the mat back into the machine. Once inserted, if the user presses the “Load Last” 670 button, the machine will recognize that the user is attempting to cut again on the same sheet of paper and use the stored CUT information to calculate whether the next set of characters or images to be cut will fit on the sheet. This feature will also allow the user to load the page and have the blade automatically return to where the previous cut ended. This is useful when the user unloads the mat to remove a cut and then returns the mat to finish cutting the rest of the page. If the “Load Last” button is not pressed, the machine will reset 672 itself so that a new sheet of paper can be used.

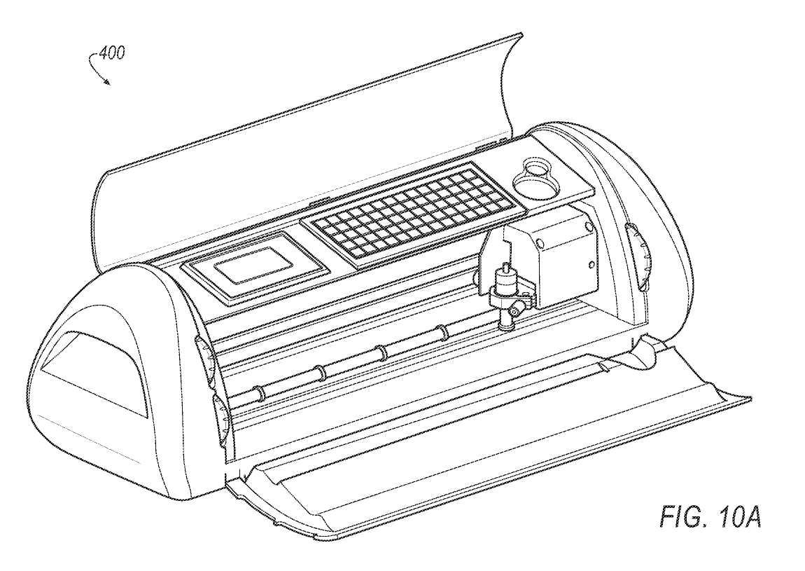

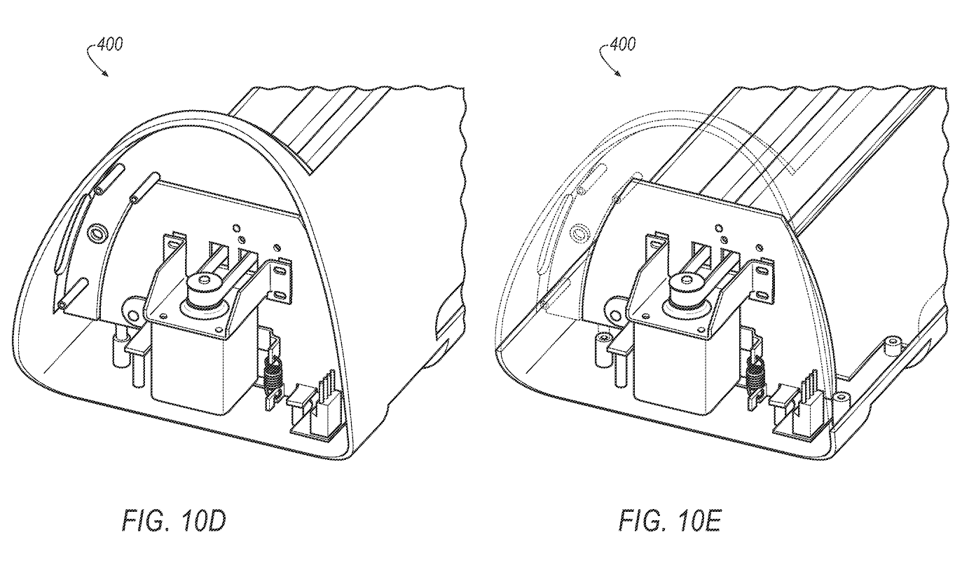

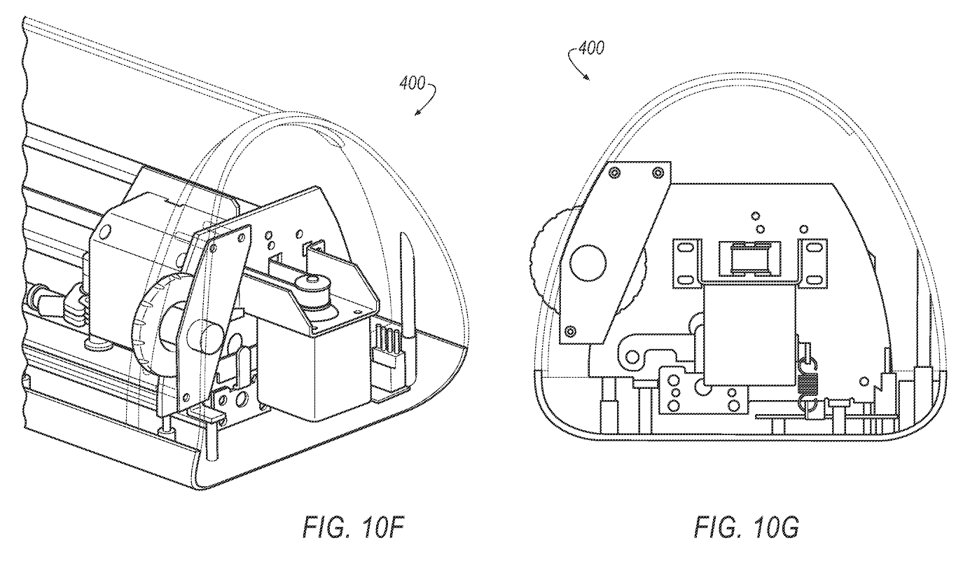

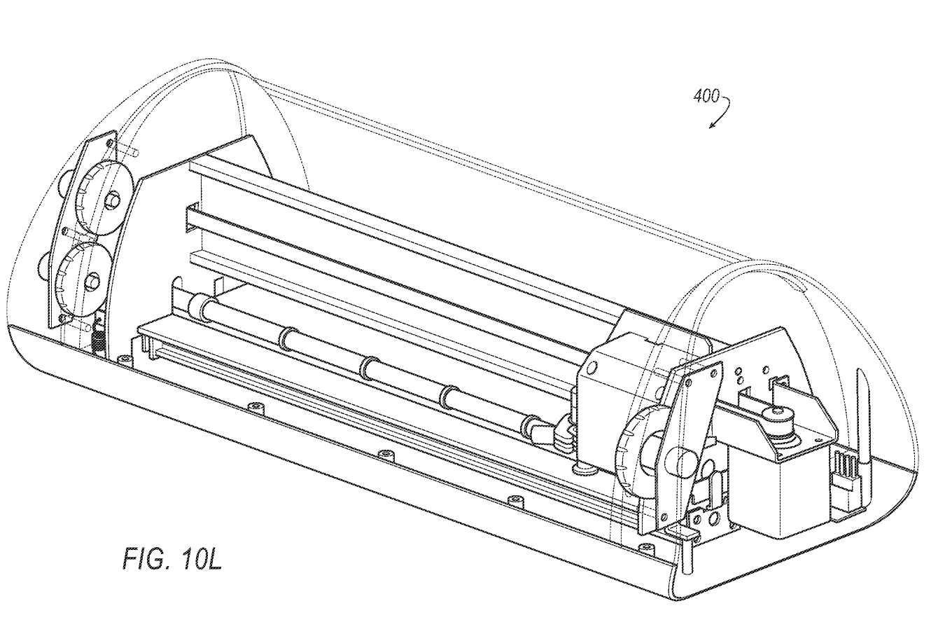

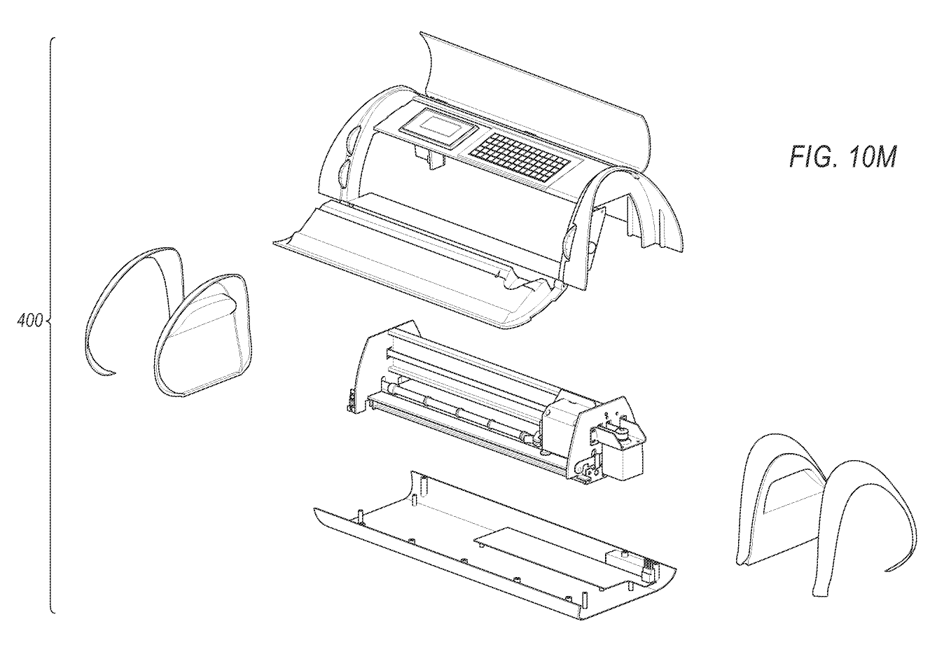

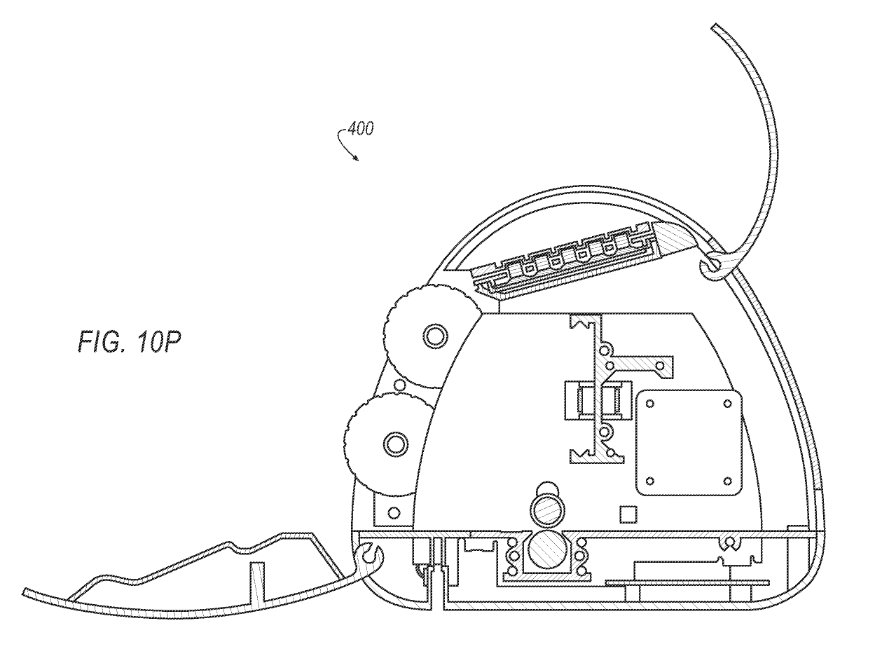

FIGS. 10A-10P show various views of the various internal and external components of a cutter machine, generally indicated at 400 In general, certain features of the machine, as compared to previous versions, are configured to make assembly, repair and replacement of individual components easier. The components are easy to access (e.g., by changing their placement), as well as easy to remove if replacement is necessary.

Cutter 400 includes a main housing to which the various components of the machine 400 are attached. Right and left end cap assemblies provide aesthetic coverings for the housing as well as providing recessed handles for grasping the sides of the machine 400. Coupled to the left side of the housing is a stepper motor attached thereto with motor mount. The motor drives the drive roller, which moves the mat (not shown), relative to the blade housing. When assembled, the drive roller is seated within the channel of the base member such that a portion of the top of the roller extends above the top surface of the base member for engaging the bottom surface of the mat.

A second stepper motor mounted relative to the right side of the housing drives the cutter assembly. When assembled the blade holder is positioned adjacent the drive roller and moves parallel thereto when cutting.

A circuit board is coupled to and housed within the bottom of the housing. The circuit board includes at least one processor and memory for controlling the movement of the stepper motors, communication with the cartridge, communication with the user interface, controlling the LCD display and communication with an external computer for firmware upgrades, cartridge content downloading, etc.

The processor of the cutter may any processor capable of executing instructions, including for example, an Atmel Mega 128 chip having 128 kb of memory or any other processor known in the art. The cartridge 435 includes its own processor, such as an Atmel Mega 8 chip, along with a four (4) or eight (8) megabyte memory chip. Alternatively, cartridge 435 may contain non-volatile memory and an interface controller for communicating with the cutter's processor. Of course, other sizes, speeds and types of processors and memory chips known in the art may be employed.

The user interface includes the keyboard assembly and cutter control buttons. The keyboard assembly includes a keypad that includes a plurality of biased keys. The cutter control buttons include a plurality of buttons. The keypad and buttons both interface with a circuit board that communicates with the processor. The keypad may be configured in a matrix for sending key presses. The buttons may be configured as part of the keypad matrix or they may be configured in their own matrix. Alternatively, each button may be configured as a direct input to the processor or circuitry, or as an interrupt (e.g., as discussed above with respect to the “stop” button). A faceplate has a plurality of recesses formed therein for receiving, supporting and maintaining the keypad and buttons. The keys of the keypad are tall enough to protrude through the recesses in the faceplate and to be received in the back of the overlay.

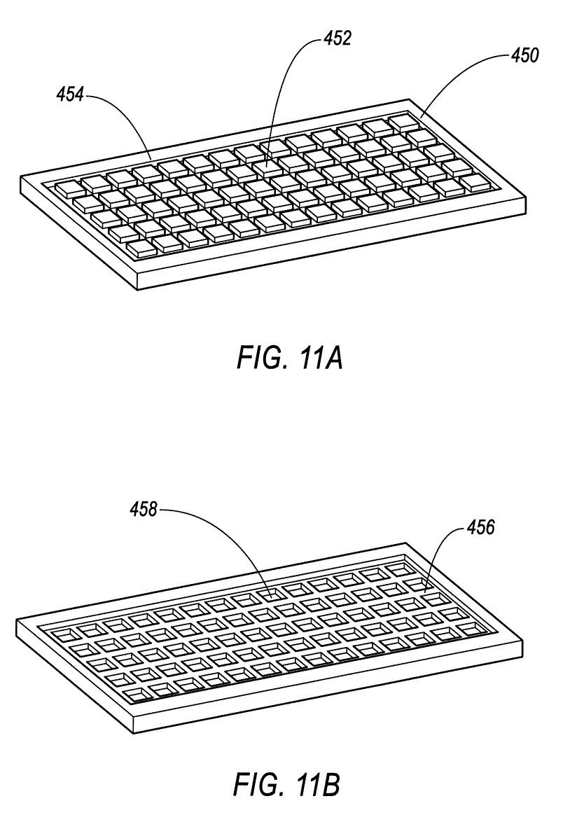

As shown in FIGS. 11A and 11B, the overlay 450 has a plurality of raised protrusions 452 on its front side 454 for being depressed by a user. On the back side 456, the overlay 450 has a plurality of corresponding recesses 458 formed therein for receiving the individual keys 442 of the keypad 440. The overlay is formed, as by molding, from a rubber-like material that is flexible and resilient to allow a user to depress the overlay and thus depress a button beneath the overlay. Thus, when the user presses a particular protrusion 452, the corresponding key beneath that protrusion is depressed. The engagement of the recesses 458 with the keys, when placed over the keys 442, holds the overlay 450 in relative position to the keys and thus the keypad to ensure that the keys are always properly aligned with the overlay.

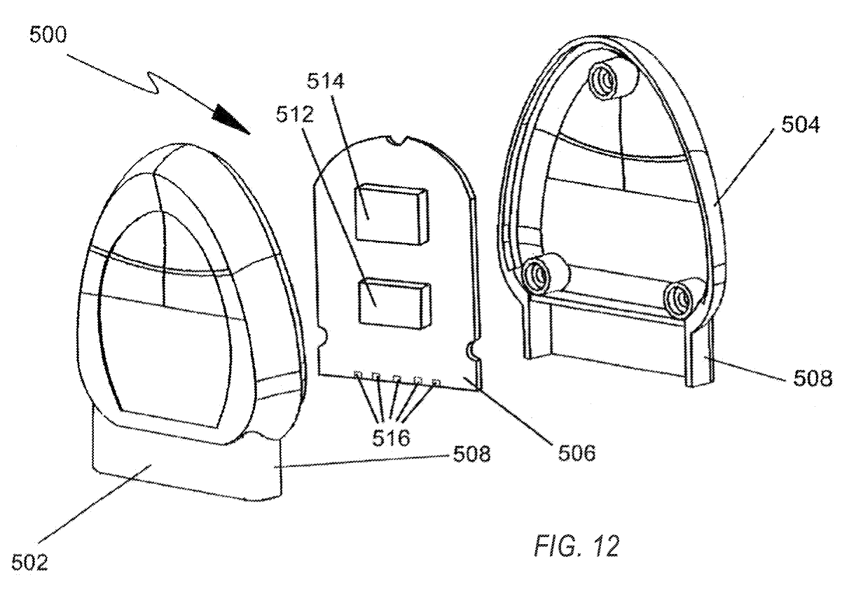

As shown in FIG. 12, a cartridge 500 is comprised of two housing components 502 and 504 that house a circuit board 506, which includes a processor 512 and memory 514. The processor 512 communicates with the cutter via circuit board terminals or contacts 516. The memory 514 stores various data in the form of algorithms that constitute the images or characters contained in the particular cartridge 500. The processor 512 communicates with the processor of the cutter to allow the transfer of the data stored on the cartridges to the cutter. As such, in a typical configuration the data contained on the cartridge cannot be modified and a new cartridge is used for each new font and/or image set. Through the port on the cutter (e.g., a USB port), the cutter will allow, in certain circumstances, the ability to upload new images, fonts, firmware updates, etc. to the cartridge and/or cutter. The housing, when assembled, forms a socket insert portion 508 that is sized and shaped to fit a socket provided in the cutter so that the contacts 516 engage with the cutter socket for communication with the cutter.

The back surface of the machine includes an elongate opening for allowing the mat to protrude through the opening during the cutting process. Also provided is a power adapter port for connecting to an electrical power cord and a USB port for attaching the cutter to an external computer. As previously discussed, however, the cutter may be fully operated without the use of an external computer attached thereto. The connection is therefore provided to all the firmware of the machine to be updated as well as for communication with the machine to allow content stored on a particular cartridge to be updated through the machine.

While the cutting machine has been described as being a completely self contained, stand-alone machine, those of skill in the art will appreciate that various components, processes and methodologies taught and described herein could be adapted for use with existing cutter machines known in the art. In addition, it is further contemplated that the cutter machine could be configured without the use of a separate cartridge such that all images, shapes and characters are stored on non-removable memory, the content of which could be updated by connection to a personal computer. In addition, if a replaceable memory module is desired, while the cartridge is shown as having a particular unique configuration, memory storage devices of known configurations could be adapted for use therein, such as the use of flash memory cards known in the art.

The machine is also provided with various unique features such as “Paper Save.” This setting will automatically rearrange the selected shapes to cluster them together and take advantage of otherwise empty space on the paper.

The cutting machine has vast capabilities that allow the user to customize the images, characters and/or shapes to be cut. For example, each cartridge contains and associated overlay provides feature buttons for custom feature effects. These features may vary with each specific cartridge to add a powerful element of expansion and versatility. In addition, the arrow buttons that surround the CUT button can be used to guide the blade to a desired location. This is very useful when needing to cut in a certain spot on the paper, especially to avoid waste. When moving away from the starting point 708 indicated on the cutting mat, the size of the image might need to be reduced in order for the machine to cut the image. If the remaining paper size is too small, the machine will alert the user and allow the user to reduce the size of the image to be cut. If sizes other than the standard size of paper for the machine are used, the user can use the blade positioning buttons and size dial to adjust for the given paper size. By pressing the “Set Paper Size” button, the user can input a custom paper size into the machine and the machine will know where “home” cut position is for the loaded sheet. The machine will cut lengthwise with “down”, as defined by the bottom of the image, being toward the left edge of the paper when viewing the machine from the front.

If material to be cut other than regular paper or cardstock is selected, the machine may be customized for such other materials. For example, the pressure dial may need to be rotated to increase or decrease the pressure of the blade against the material to be cut to allow the blade to completely cut through the material without tearing the material. In addition, some paper materials may require a slower cutting speed. Thus, the speed dial can be decreased to allow the blade to cut without tearing. For thicker or thinner materials, the blade depth can be adjusted by rotating the blade housing adjustment knob as previously discussed.

The default size of images and shapes for the machine is “relational.” This means that the entire cut results for a given character set will be in proportion to the largest possible character or image contained in the set (referred to as Key Height Character). This maintains letters correctly sized in relation to each other. By pressing the “Real Dial Sizing” button, however, the literal size of images or letters is selected. Thus, for example, the letter “c” will be shorter when cut than the letter “f”.

Additional features include digital sizing in 0.1 inch increments (2.3″, 3.1″, etc.) and Incremental Rotate that allows for rotation of the glyph. The rotation feature may be employed through an additional dial that allows the user to “spin” the glyph around a central axis, but also allows the glyph to be rotated at set intervals, such as 45-degree and/or 90-degree increments. Digital sizing may be accomplished with, for example, rotation of dial 20 (see FIG. 1) or using keys associated with rotation on the keypad, or using the soft keys.

When setting up electronic cutter 10 for operation, many features can be applied to characters/shapes. For example, when the user wishes to cut out a character-based message, each character may be assigned different attributes. Each attribute may be set by selecting the existing character (e.g., using positioning keys and the display) and using the keyboard 40 or dials 18, 19, 20 to modify the features. For example, size, position, rotation, skew, italic, and other parameters may be modified for each character or shape. Moreover, when multiple graphics or shapes are to be cut (e.g., when a quantity greater than one is selected) each graphic or shape may be individually customized for the features. Alternatively, the user may apply the customized features to all of the characters/shapes. Each character maintains its own list of “feature” attributes based on the user's selection or customization. In one example of use, the user may move a cursor on the display to select a character. The user may then review and/or modify any feature selection for the selected character. To assist the user, various feature button LEDs may become lighted when a feature is selected. In this way, the feature selection buttons provide feedback to the user as to the status of the feature as applied to the selected character. Such a system providing for the assignment of features to each individual character may be called a mix-and-match system (e.g., or a “mix-'n-match” feature).

Other system features may include a “flip” feature that allows for mirroring of a character/shape (see FIG. 17). For example, the user's selection of the “flip” feature (e.g., as assigned on keyboard 40) allows the user to mirror a character along a vertical center-line of the character. This feature is useful, in an example, as allowing the user of paper when cut from the “back” side (e.g., when using a self-adhesive).

An “auto-fill” feature may be used to fill a page with as many instances of the current character/shape as will generally fit on the remainder of the page. The auto-fill feature can be useful when cutting a large number of the same shape.

An “auto-expand” feature allows for the resizing of a character/shape or a collection of characters/shapes to generally fill the remainder of the page. The auto-expand feature may be used to maximize the used are of the page. In an example, the auto-expand function is applied to a collection of twelve characters/shapes. The entire collection is scaled up to cover the entire page. Thus, maximizing the size of the collection given the page size.

A “quantity” feature allows the user to select the number of cuts that are applied to the current characters selected, or the collection. For example, when the quantity feature is selected, the user is queried for the “number of cuts” (e.g., the number of total number of times each character will be cut). The user may press the “quantity” button (e.g., on the keyboard) and then enter the number of cuts using dial 20 or the arrow keys on the keyboard. The user is then prompted to begin cutting. Once cutting is authorized by the user, the display may show the status of the number of cuts, providing an indication of cutting progress to the user. If multiple pages are required to complete the number of cuts, the system prompts the user to insert a new page and then resume the cutting operation. At any time, the user may press the “stop” button to exit the quantity feature (e.g., during setup or after cutting has begun).

A “center point” feature allows the user to cut a shape around a center point. The user sets up the center point function by positioning the cutter over the center of the desired cut area. The user then presses the “center point” button on the keyboard to indicate the center position. The user then selects the shape to be cut and then initiates the cutting operation. One example of the center point feature includes cutting an oval shape from a photograph (shown in FIG. 18).

A “multi-cut” feature may be useful to make multiple cuts along the same lines. This allows for cutting of thicker material, such as chipboard. When the multi-cut feature is used, a first pass is made to initially cut the material, but may not cut all the way through the material. On a second pass (e.g., of the multiple cutting function) another cut is made following the path of the original cut. This allows the blade to cut deeper into the material. The number of re-cuts the machine makes may be set either by a setup feature or in response to user prompt each time the feature is turned on.

A “line return” feature would allow the user to insert line returns such as is allowed when using a word processor (see FIG. 19). This gives the user greater flexibility for configuring the cutting pattern, for example when the user wishes to leave a larger rectangular area in one corner of the mat for placing a larger character/symbol.

It is understood that the terminology used herein is used for the purpose of describing particular embodiments only and is not intended to limit the scope of the present invention. In addition, the use of the term “shape” herein, refers to a particular image, font or character that may be stored on the machine of the present invention, on a cartridge for the machine or in any other location for being cut by the machine. Moreover, the use of the term “sheet” herein refers to any material in sheet form that can be cut with electronic cutter 10 as described herein, including without limitation papers of various thicknesses including such materials as colored papers and card stock as well as sheets of plastic, cardboard, foil or other materials known in the art. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods, compositions, and materials of the present invention are described herein, any methods and materials similar or equivalent to those described herein may by used in the practice or testing of the present invention. All references cited herein are incorporated by reference in their entirety and for all purposes.

While the foregoing advantages of the present invention are manifested in the illustrated embodiments of the invention, a variety of changes can be made to the configuration, design and construction of the invention to achieve those advantages. Hence, reference herein to specific details of the structure and function of the present invention is by way of example only and not by way of limitation.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. The embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. An apparatus, comprising:
a housing;
a cutting mechanism coupled to said housing and configured for cutting a sheet;
a user interface incorporated into said housing for allowing a user to select through said user interface at least one shape to be cut by said cutting mechanism;
a processor housed within said housing for controlling movement of said cutter assembly and for receiving commands through said user interface; and
a memory device in communication with said processor, said memory device containing a library of shapes to be cut with said cutting mechanism for selecting by a user through said user interface.

2. The apparatus of claim 1, said cutting mechanism further comprising:
a drive roller for moving said sheet along a first axis; and
a cutter movable along a second axis, wherein said first axis and said second axis are substantially perpendicular.

3. The apparatus of claim 1, further comprising:
a cover coupled to said housing, said cover being at least transparent allowing the user to view at least a portion of said user interface.

4. The apparatus of claim 1, said user interface further comprising a display.

5. The apparatus of claim 1, further comprising:
a memory storage device comprising descriptions of a plurality of shapes, whereby said memory storage device describes said combined controlled movement of said drive roller and said cutter that causes a shape to be cut in the sheet.

6. The apparatus of claim 1, wherein said memory device is removable.

7. An apparatus comprising:
a housing;
a sheet moving mechanism coupled to said housing for moving a sheet along a first axis, the sheet;
a cutter coupled to said housing and configured to cut said sheet, said cutter being moveable along a second axis substantially perpendicular to said first axis; and
a user interface coupled to said housing for allowing a user to select through said user interface at least one shape to be cut by said cutter,
whereby combined controlled movement of said drive roller and said cutter causes a shape to be cut in the sheet.

8. The apparatus of claim 7, wherein said sheet moving mechanism comprises a drive roller.

9. The apparatus of claim 7, further comprising:
a cover coupled to said housing, said cover being at least transparent allowing the user to view at least a portion of said user interface.

10. The apparatus of claim 7, said user interface further comprising a display.

11. The apparatus of claim 10, wherein said display is hingedly coupled to said housing.

12. The apparatus of claim 7, further comprising:
a memory storage device comprising descriptions of a plurality of shapes, whereby said memory storage device describes said combined controlled movement of said drive roller and said cutter that causes a shape to be cut in the sheet.

13. The apparatus of claim 7, further comprising:
a first end cap disposed at a first end of said housing, said first end cap including a first recessed region; and
a second end cap disposed at a second end of said housing; said second end cap including a second recessed region,
whereby said first recessed region and said second recessed region provide handholds for the user.

14. The apparatus of claim 7, further comprising:
a mat configured to removably accept the sheet.

15. The apparatus of claim 14, further comprising:
an optical reader directed near the sheet; said optical reader determining the approximate size of at least one of the sheet and the mat.

16. An apparatus comprising:
a housing;
a sheet moving mechanism coupled to said housing for moving a sheet to be cut along a first line of motion;
a cutter coupled to said housing moveable along a second line of motion, said second line of motion being substantially perpendicular to said first line of motion; and
a user interface coupled to said housing for allowing a user to select through said user interface at least one shape to be cut through the sheet by said cutter,
a processor for controlling movement of said cutter assembly and for receiving commands through said user interface; and
a removable memory device in communication with said processor, said removable memory device including a description of said at least one shape, whereby said processor controls movement of said drive roller and said cutter that causes the shape to be cut in the sheet based on said description.

17. The apparatus of claim 16, further comprising:
a cover coupled to said housing, said cover being at least transparent allowing the user to view at least a portion of said user interface.

18. The apparatus of claim 16, said user interface further comprising a display.

19. The apparatus of claim 16, further comprising:
a mat configured to removably accept the sheet.

20. The apparatus of claim 19, further comprising:
an optical reader directed near the sheet; said optical reader determining the approximate size of at least one of the sheet and the mat.
